(19) United States
(12) Patent Application Publication
(10) Pub. No.: US 2019/0230414 A1
(43) Pub. Date: Jul. 25, 2019

(54) PRIMARY DEVICE AND COMPANION DEVICE COMMUNICATION

(71) Applicant: Sharp Kabushiki Kaisha, Sakai City, Osaka (JP)

(72) Inventor: Sachin G. DESHPANDE, Camas, WA (US)

(21) Appl. No.: 16/314,870

(22) PCT Filed: Jun. 20, 2017
(86) PCT No.: PCT/JP2017/022616

§ 371 Date: Jan. 3, 2019

Related U.S. Application Data
(60) Provisional application No. 62/362,006, filed on Jul. 13, 2016.

(51) Int. Cl. H04N 21/472; H04N 21/436; G06F 9/54

(52) U.S. Cl. CPC H04N 21/472; G06F 9/542; H04N 21/43615

(57) ABSTRACT

A system and method for generating, providing and/or receiving services for companion devices and for communication between primary device and companion device.

### CROSS REFERENCE

This Nonprovisional application claims priority under 35 U.S.C. § 119 on provisional Application No. 62/362,006 on Jul. 13, 2016, the entire contents of which are hereby incorporated by reference.

### TECHNICAL FIELD

The present disclosure relates generally to companion devices also known as second screen devices and services.

### BACKGROUND ART

A video service is capable of sending audiovisual content to a receiving device. The receiving audiovisual device typically presents the content to the viewer, such as on a television device. In some cases, the viewer would like to use their mobile device, such as a mobile phone, to interact with the video content. However, how to most effectively interact with the audiovisual content on the receiving device using the mobile phone tends to be problematic due to synchronization issues. In one case the viewer may want to receive audiovisual content on a receiver such as a television device. At the same time the user may want to receive adjunct associated content on a second screen, e.g. a mobile device such as a smartphone or a tablet. The content received on the second screen device may be same as alternate content associated with the audiovisual content being received on the television. The user may typically like these two contents be presented on the primary and second screen device in a synchronized manner.

The foregoing and other objectives, features, and advantages of the invention will be more readily understood upon consideration of the following detailed description of the invention, taken in conjunction with the accompanying drawings.

### SUMMARY OF INVENTION

An aspect of the invention is a method for a companion device to receive, in response to a subscription requested from said companion device to a primary device, a subscription message and a notification message comprising: (a) receiving said subscription message that includes service enumeration value that includes a value indicating media timeline service; (b) receiving said notification message that includes notification service enumeration value that includes a value indicating media playback state value; and (c) processing said subscription based upon said subscription message and said notification message.

### BRIEF DESCRIPTION OF DRAWINGS

FIG. 1 illustrates a video system.

FIG. 2 illustrates a primary device (PD) and a companion device (CD) system.

FIG. 3 illustrates another primary device and a companion device system.

FIG. 4 illustrates another primary device and a companion device system.

FIG. 5 illustrates another primary device and a companion device system.

FIG. 6 illustrates another primary device and a companion device system.

FIG. 7 illustrates another primary device and a companion device system.

FIG. 8 illustrates another primary device and a companion device system.

FIG. 9 illustrates an emergency alert system.

FIG. 10 illustrates another primary device and a companion device system.

FIG. 10A illustrates another primary device and a companion device system.

FIG. 11 illustrates another primary device and a companion device system.

FIG. 12 illustrates another primary device and a companion device system.

FIG. 12A illustrates another primary device and a companion device system.

FIG. 12B illustrates another primary device and a companion device system.

FIG. 12C illustrates a non-linear timeline change based event notification.

FIG. 12D illustrates another non-linear timeline change based event notification.

FIG. 13 illustrates another primary device and a companion device system.

FIG. 14 illustrates another primary device and a companion device system.

FIG. 15 illustrates a primary device and a companion device system.

FIG. 16 illustrates a primary device and a companion device system.

FIG. 17 illustrates a primary device and a companion device system.

FIG. 18 illustrates a primary device and a companion device system.

FIG. 19A illustrates a JavaScript Object Notation (JSON) schema.

FIG. 19B illustrates the next part of FIG. 19A

FIG. 20 illustrates a JSON schema.

FIG. 21A illustrates a JSON schema.

FIG. 21B illustrates the next part of FIG. 21A.

FIG. 21C illustrates a JSON schema.

FIG. 22 illustrates an eXtensible Markup Language (XML) schema.

FIG. 23 illustrates a structure of message structure elements.

FIG. 24A illustrates a XML schema.

FIG. 24B illustrates the next part of FIG. 24A.

FIG. 25 illustrates a structure of message structure elements.

FIG. 26 illustrates a JSON schema.

FIG. 27 illustrates a JSON schema.

FIG. 28 illustrates a primary device and a companion device communication.

FIG. 29 illustrates service enumeration values.

FIG. 30 illustrates notification service enumeration values.

FIG. 31 illustrates schema for subscription related messages.

FIG. 32 illustrates schema for notification related messages.

FIG. 33 illustrates schema for media timeline information.

### DESCRIPTION OF EMBODIMENTS

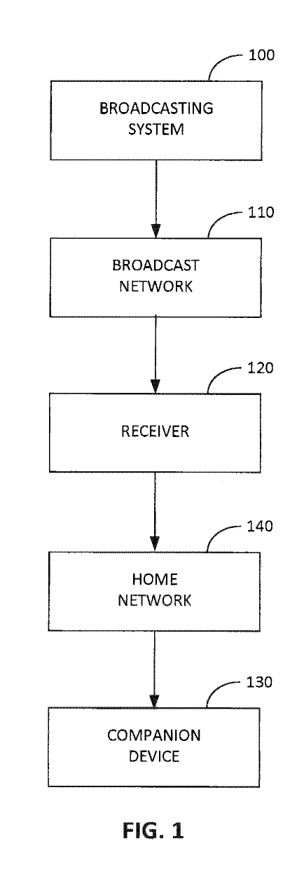

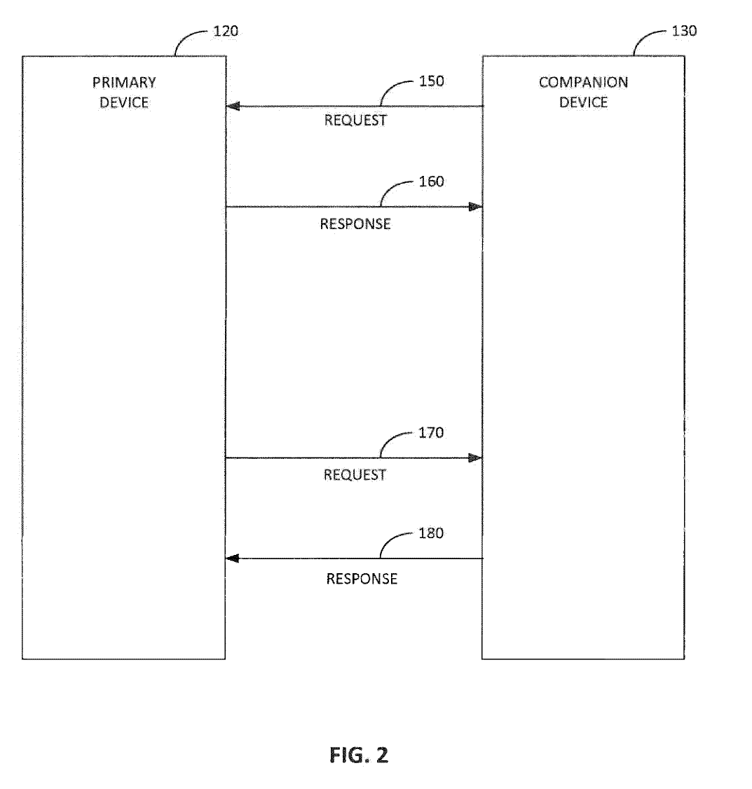

Referring to FIG. 1, a logical architecture of an audiovisual system is illustrated. The system includes a broadcasting system 100 that provides a source of audiovisual (video and/or audio and/or closed caption) content. The audiovisual content may be provided in any suitable manner and using suitable standards, such as for example, Motion Pictures Expert Group (MPEG) standards or Advanced Television Systems Committee (ATSC) standards. By way of example, the broadcasting system may be provided from a broadcasting antenna, a cable, a network based audiovisual source, a compact disk, a hard drive, a digital video disc, and/or an Internet based audiovisual source. The broadcasting system 100 may provide the content through any suitable broadcast network 110. A receiver 120 receives the audiovisual content together with any other data provided with the audiovisual content, such as digital data, data services, or otherwise. The receiver 120, generally referred to as a primary device, is preferably configured to receive the type of content being provided there to. The receiver may be, for example, a television, a laptop, a tablet, a phone, a computing device, a set top box, a streaming device, or any other device suitable to receive the audiovisual content. The receiver may be typically in a user's home. The receiver may likewise communicate with another device 130, generally referred to as a CD, through a home network 140. In another embodiment the CD may communicate directly with an outside server to receive audiovisual and/or adjunct content. The home network is preferably a wireless or wired type network, such as for example, Wireless Fidelity Alliance (Wi-Fi), Ethernet, Third Generation Partnership Project (3GPP), Bluetooth, infra-red, Hypertext Transfer Protocol (HTTP). In some cases the home network may be a local area network. In some cases the primary and CDs may be inside a user's home. In other cases, the home network may be an office environment. The CD may include, for example, a mobile phone, a mobile tablet, a laptop, a computer, or other display device. In addition, the receiver may simultaneously communicate with one or more CD(s) 130. Additionally one CD may communicate simultaneously with multiple PDs 120. In some embodiments the PD may be called a first screen device. In some embodiments the CD may be called a second screen device. The terms PD and first screen device and receiver may be used interchangeably. The terms second CD and second screen device may be used interchangeably. Referring to FIG. 2, it is often desirable that the PD 120 is capable of providing information to the CD 130. In addition, the CD 130 may provide information to the PD 120. Often, the CD 130 makes a request 150 to the PD 120, which in response thereto provides a response 160 to the CD 130. In other cases, the PD 120 makes a request 170 to the CD 130, which in response thereto provides a response 180 to the PD 120. This permits the PD 120 to display content thereon, and the CD 130 may likewise interact with the PD 120. For example, it may be desirable that whatever is being presented on the PD 120 is simultaneously being presented on the CD 130, which may include for example, audio and/or video content. For example, it may be desirable to present a primary view of the video content on the PD 120 and simultaneously present an alternative view of the same or similar scene of the video content on the CD 130. For example, it may be desirable to present audiovisual content on the PD 120 and simultaneously interact with an associated application that is started (or automatically started) on the CD 130. In this case typically the content being presented on the PD and the CD should be synchronized. The synchronization refers to displaying the data corresponding to the same or approximately same time instance on the primary and the CD.

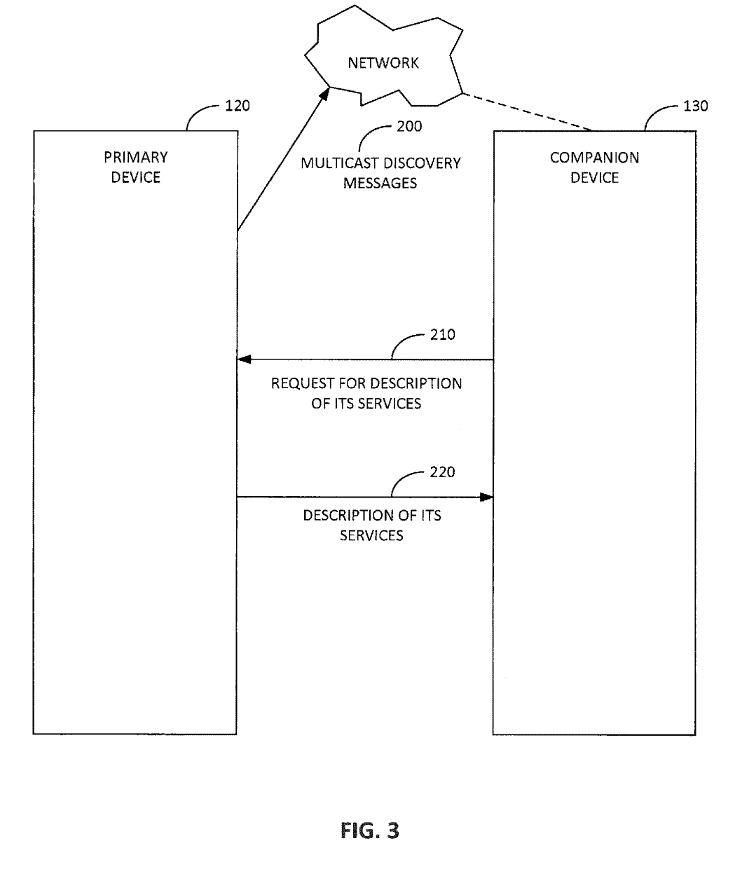

Referring to FIG. 3, by way of example, the user may have a CD 130 with an application running thereon when a PD 120 (e.g., a television) joins the network. This may occur, for example, when the receiver is turned on or its network interface is enabled. The PD 120 may be capable of providing services for the CD 130. The PD 120 may multicast its discovery messages 200 to advertise its second screen support services. The CD 130 receives the multicast discovery messages and sends the PD 120 a request for descriptions of its services 210. The PD 120 responds to this request with a description of its services 220. The CD 130 uses the information provided in the descriptions to access the appropriate services and provide an interactive experience synchronized with the programming on the PD 120.

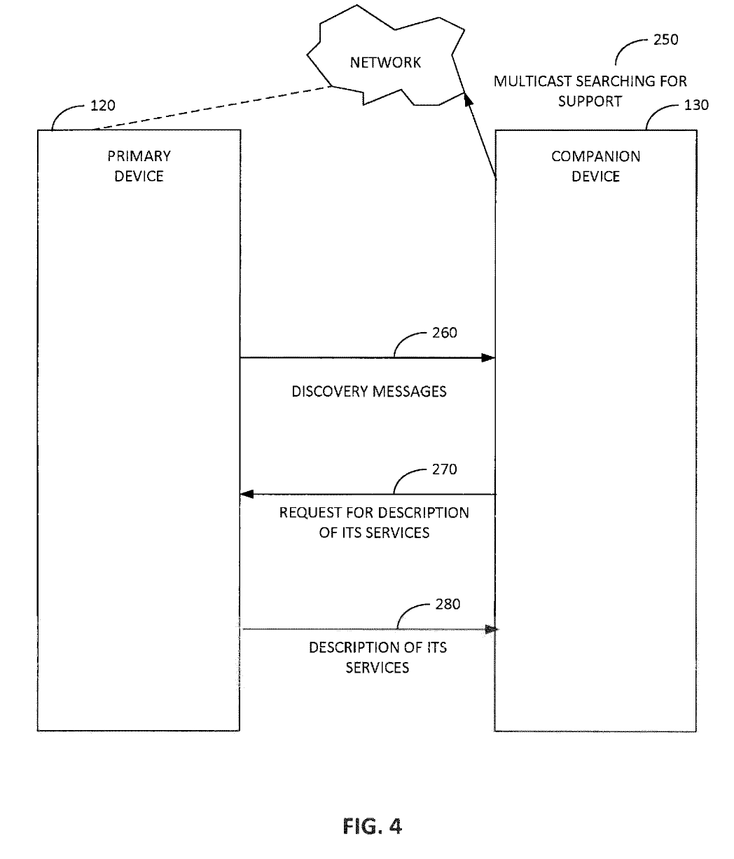

Referring to FIG. 4, by way of example, the user may not have a CD 130 with an application running thereon when the PD 120 (e.g., television) joins the network. The audiovisual content being viewed on the PD 120 may enter a program segment that offers CD 130 support. This may occur, for example, when the receiver is turned on or its network interface is enabled, or when a channel change goes from a channel that does not offer the CD 130 with another that does offer support for the CD 130, or when the channel being viewed goes from a program segment that does not offer support for the CD 130 to a segment that does offer support for the CD 130. This viewing change causes the PD 120 to inform the viewer in some manner that CD 130 support is available. For example, a small icon may be presented in the corner of the PD 120. If the viewer decides to take advantage of the second screen support and activate an application on the CD 130, then the CD 130 may multicast a message 250 searching for devices that offer CD 130 support or service. In an example, the CD 130 may multicast a message 250 searching for devices that offer support or service that is compliant with a standard; for example, an ATSC standard, a Digital Video Broadcasting (DVB) standard, a Hybrid Broadcast Broadband TV (HbbTV) standard, or other suitable standard. The PD 120 may respond to this message with its discovery messages 260. When the CD 130 receives the discovery messages, it sends the PD 120 may receive a request for descriptions of its services 270. The PD 120 responds with description of its services 280. The CD 130 uses the information given in the descriptions to access the appropriate services and provide an interactive experience synchronized with the audiovisual content.

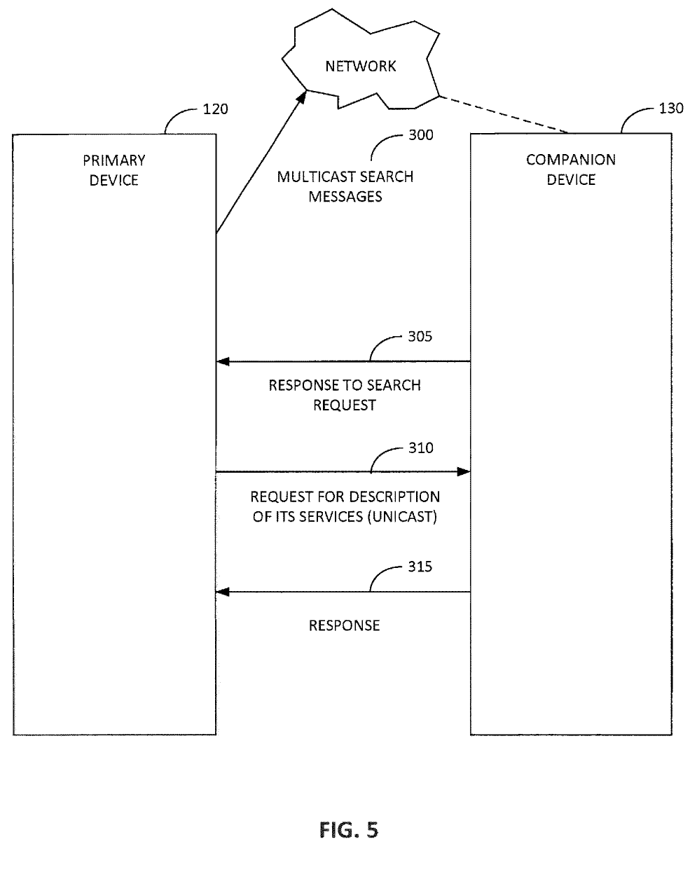

Referring to FIG. 5, by way of example, the viewer has a CD application running when the PD joins the network (e.g., when the PD is turned on or the network interface is enabled). The PD 120 desires to discover one or more CD(s) 130 on the network. The PD 120 joins the network and sends multicast search messages 300 seeking one or more CD(s) 130. The CD 130 running an application receives the multicast search message 300 and in response sends the PD 120 a response to search request 305. On receiving this response the PD 120 may send a request for the description of services 310 that CD offers to PD. The request for the description of services 310 may be sent via a unicast technique, rather than a multicast technique. On receiving the request for the description of services 310 the CD responds with a description of its services by sending a response 315 to the PD. The PD 120 receives the response 315 and uses the information given in the service descriptions to access the appropriate services and to understand the capabilities of the CD 130.

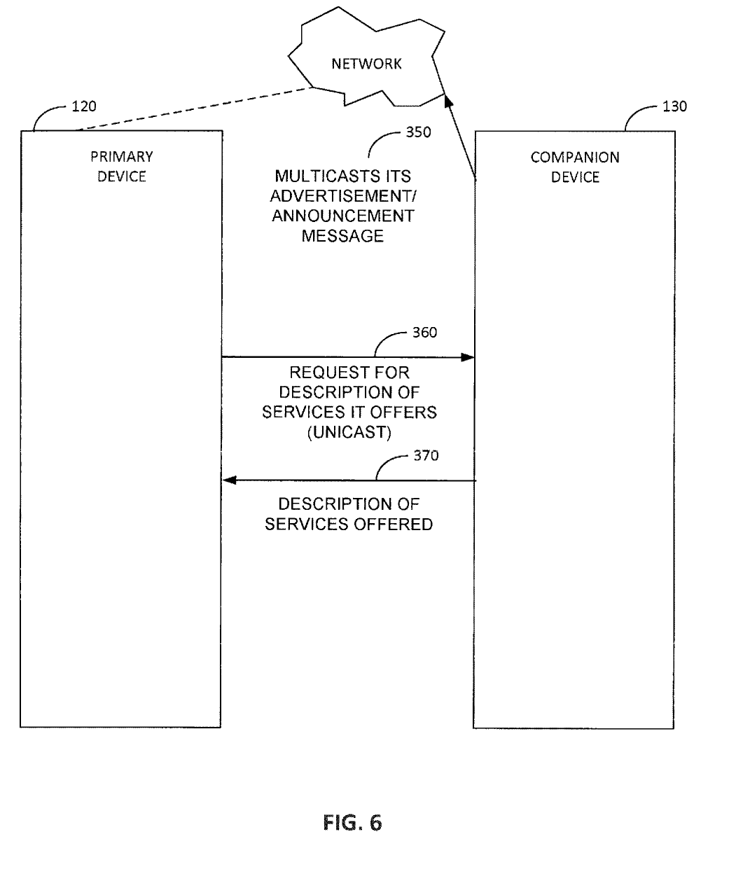

Referring to FIG. 6, by way of example, a CD 130 joins the network and/or an application is started on a CD 130. The PD 120 is already on the network. The CD 130 multicasts its advertisement or announcement message 350 that announces the CD 130 and its available services. The PD 120 receives the multicast advertisement message from the CD 130 via network and sends the CD 130 a request for descriptions of the services it offers (unicast) 360. The message may be sent via unicast, rather than multicast. The CD receives the message and responds with a description of the services offered 370 to the PD 120. The PD 120 uses the information given in the service descriptions to access the appropriate services and to understand the capabilities of the CD.

As illustrated in FIGS. 3-6, the household may have more than one CD on the home network and the household may have more than one PD on the network. In this case each CD would receive lookup messages from multiple different PDs via network. Also multiple PDs will receive announcement messages from multiple CDs via network.

As noted above, in some environments, there may be more than one PD 120, especially when using the home network. In this case, the CD 130 may receive discovery messages from one or more PD(s) 120 via network. If that happens the CD 130 may query the user for the PD 120 to interact with.

A typical application on the CD 130 may operate as follows. A control point or service on the CD 130 subscribes to a packaged apps service on the PD 120. A packaged app may be an application on the device offering service. A viewer starts the packaged app on the PD 120 The packaged app makes the name of application on the CD 130 and the Uniform Resource Locator (URL) of the application on the CD 130 available to the packaged app service. The control point on the CD 130 receives the companion application name and URL. The control point sets a marker on the CD 130 indicating that viewer action is needed. The viewer reviews the companion application name and selects it. The control point launches the indicated application on the CD 130 as indicated by ATSC Candidate Standard: Interactive Services Standard (A/105:2014), Apr. 24, 2014 (513-2-389r7), incorporated by reference herein in its entirety.

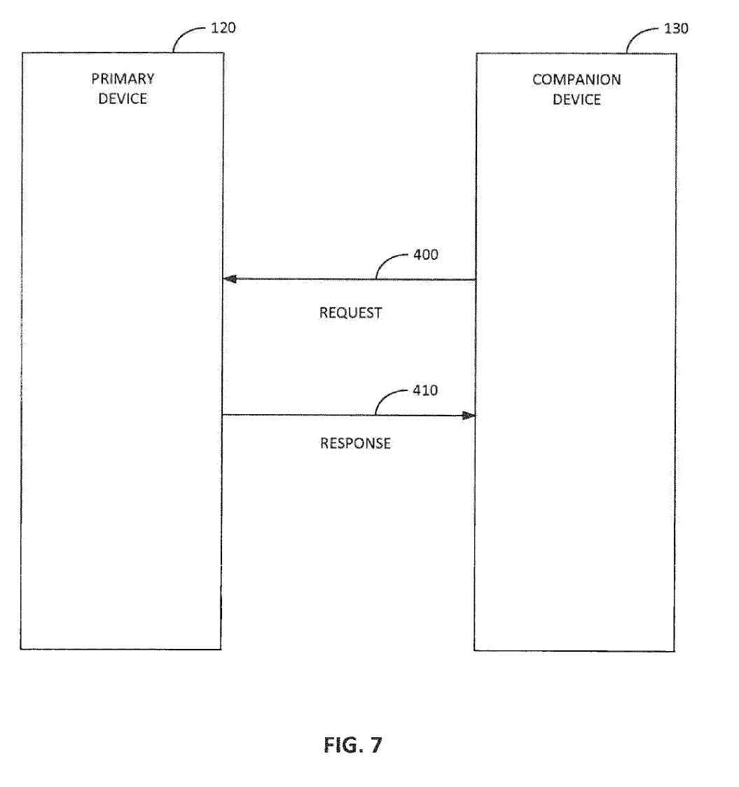

Referring to FIG. 7, it is desirable for the CD 130 to request information from the PD 120 about the current audiovisual content being presented on the PD. While the CD 130 may make a request to subscribe to the receive the information about content being presented the PD 120 which provides a response with an Identifier (ID) for the content, and then make a request for the content based upon the ID, this is a cumbersome process. In addition, in the event that the content being displayed on the PD 120 changes, then the ID provided by the CD 130 that was previously received will refer to different content than that currently being presented on the PD causing a disrupted experience for the viewer using the CD 130. To alleviate the concern about receiving a response that does not correspond to the currently displayed audiovisual content, the CD 130 preferably makes a single request 400 to the PD 120 for information about the currently running service, program and/or show, and/or segment without having to provide an identification of the currently running service, show, and/or segment. The PD 120, in response to receiving the request 400, provides a response 410 with the desirable information. The desirable information may include, for example, an electronic service guide type information about the content currently being presented on the PD

For example the CD 130 may make a request to the PD 120 to receive current service information. This may be invoked at any time when needed by the application. The input parameters for this request may include one or more of the following:

Companion Device ID

Companion Device Application ID

Companion Device Application Version

Current information requested may include one or more of following:

Request for current show information (e.g., electronic service guide information for the current show being presented on the PD);

Request for currently available components for the current show being presented on the PD (e.g., video, audio, closed captioning, main camera view, alternative camera view, etc. for the content being presented on the PD);
Request for currently available files and/or non-real-time content for the current show being presented on the PD;
Optionally the request may include a filtering criterion which may be used to limit the amount of information being requested in response thereto.

An example of the filtering criterion may be e.g., standard definition video only, high definition video or ultra high definition video, black/white video, color video, 5.1 channel audio, or stereo audio etc.

For example the PD 120 may send a response to the CD 130 after receiving the above request. This may preferably be sent upon receiving a service information request. The response 410 parameters may include one or more of the following:

Primary device ID

Requested information about the current show may include one or more of following:

Current show information (e.g., electronic service guide);

Information about currently available components for the current show (e.g., video, audio, closed captioning, main camera view, alternative camera view);

Currently available files and/or non-real-time content for the current show.

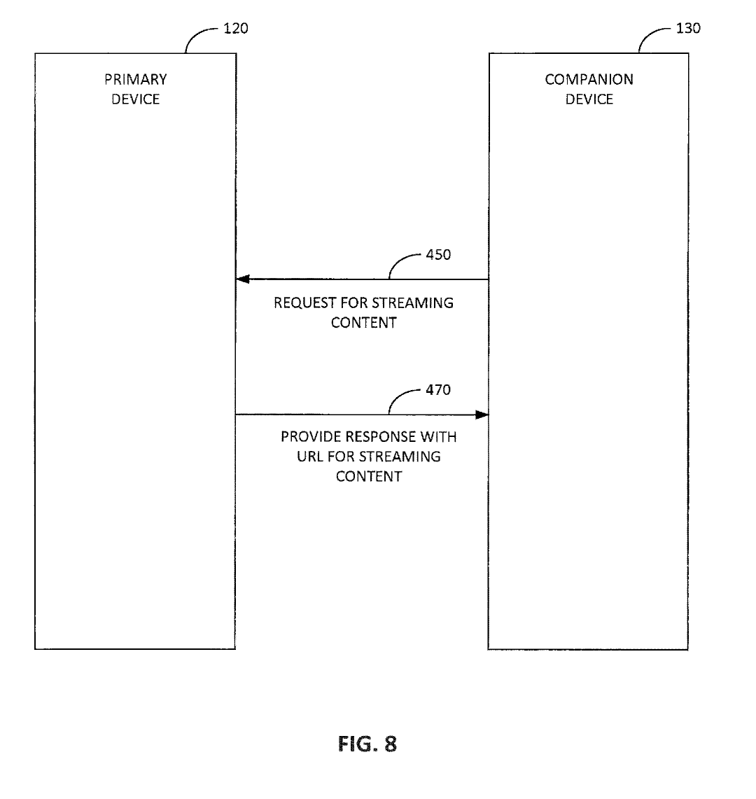

Referring to FIG. 8, when the CD 130 is accessing audiovisual information from the PD 120 and when the CD 130 is accessing audiovisual information from another source, such as the Internet or a network location, it is desirable that both sources of such audiovisual information are addressed and obtained in a similar manner. The request for streaming content 450 from the CD may result in PD 120 providing response with URL for streaming content 470, that includes a location identification for the audiovisual content whether the location of the audiovisual information is from the PD 120 or from another location, such as the Internet or a network.

For example the CD 130 may make a request to the PD 120 to receive service information. This may be invoked at any time when needed by the application or otherwise to continuously receive the streaming information. The input parameters may include one or more of the following:

Companion Device ID

Companion Device Application ID

Companion Device Application Version

Current information requested may include one or more of following:

Request for current show information (e.g., electronic service guide information for the current show being presented on the PD);

Request for currently available components for the current show being presented on the PD (e.g., video, audio, closed captioning, main camera view, alternative camera view, etc. for the content being presented on the PD);
Request for currently available files and/or non-real-time content for the current show being presented on the PD;
Optionally the request may include a filtering criterion which may be used to limit the amount of information being requested in response thereto.

An example of the filtering criterion may be e.g., standard definition video only, high definition video or ultra high definition video, black/white video, color video, 5.1 channel audio, or stereo audio etc.

For example the PD 120 may send a response to the CD 130 after receiving the above request. This may preferably be sent upon receiving a service information request. The response parameters may include one or more of the following:

Primary device ID

Requested information about the current show may include one or more of following:

Current show information (e.g., electronic service guide)

Information about currently available components for the current show with URLs (which include information about protocol, Internet Protocol (IP) address, port, etc.) for accessing the streaming data for each component (e.g., video, audio, closed captioning, main camera view, alternative camera view)

Currently available files and/or non-real-time content for the current show

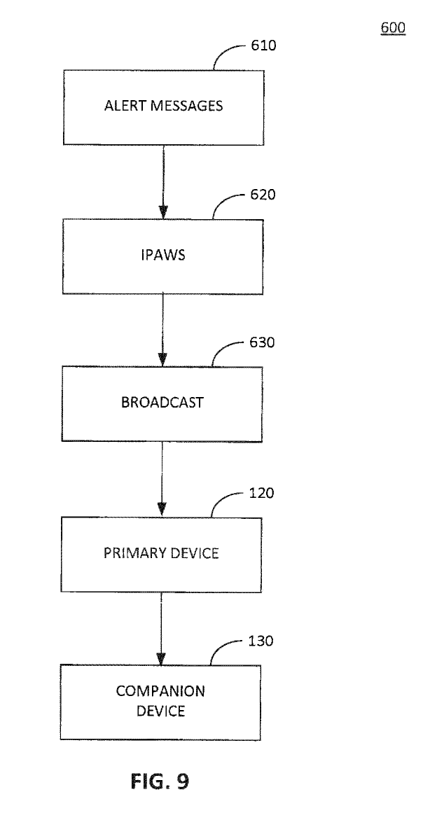

Referring to FIG. 9, an emergency alert system 600 may include alert messages 610 formatted in a common alerting protocol and further constrained by a profile of an integrated public alert and warning system (IPAWS) 620. These formatted and constrained alert message files may be issued by a suitable party, such as a federal or state agency. The alert message is broadcast 630 by a broadcaster. The PD 120 may receive these alert messages and selectively provide them to one or more CD(s) 130.

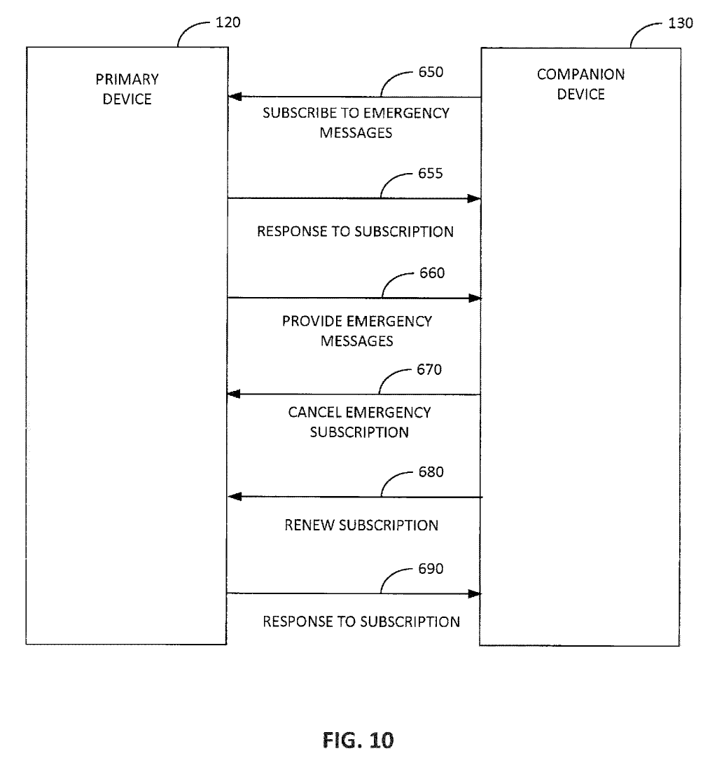

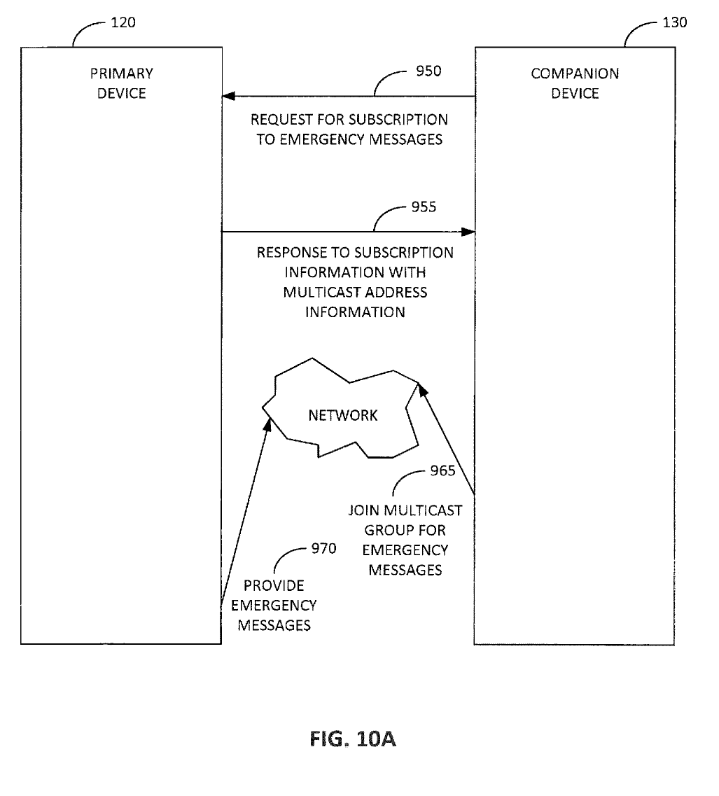

Referring to FIG. 10, the CD 130 may subscribe to emergency messages 650 from the PD 120. The subscription request preferably includes a callback URL. The PD may accept the subscription and send a response to subscription 655 to the CD 130 including a subscription ID. When an emergency message is received by the PD 120, it may provide emergency message 660 to the CD 130 that has subscribed to the emergency messages using the callback URL previously provided with the subscription. The emergency message may be provided as a notification message.

The CD 130 may make the subscription to emergency messages when the CD 130 joins the network or when an emergency message application is started on the CD 130. The input parameters may include one or more of the following:

Companion Device ID

Companion Device Application ID

Companion Device Application Version

Subscription callback URL information

Optional: emergency message filtering criteria (e.g., geographic location filtering to provide emergency messages corresponding to only the specified location).

For example the PD 120 may provide the emergency message subscription response to the CD 130. This may be sent preferably upon receiving the subscription information. The subscription response may include one or more of the following:

Primary device ID

Subscription ID

Subscription duration (e.g., so that the emergency messages are not provided indefinitely, but rather for a reasonable duration that may be appropriate, such as 12 hours)

The CD 130 may send PD 120 a cancel emergency message subscription 670 message to the PD 120. Based upon the subscription duration, the CD 130 may send a message to the PD 120 to subscribe to emergency messages 650 (or otherwise renew subscription 680). The parameters provided for the renewal of a subscription may include one or more of the following:

Companion Device ID

Companion Device Application ID

Companion Device Application Version

Subscription ID

In this case, the PD already has the callback URL and geographic filtering information, and the renewed subscription is based upon the subscription ID.

When the PD 120 receives a subscription renewal or a subscription stop request it may provide a response to subscription 690 to the CD 130, if desired. The response may include one or more of the following:

Principal Device ID

Subscription ID,

Subscription Duration for subscription renewal request

Success or Failure for subscription stop request

Referring to FIG. 10A, the CD 130 may send request for subscription information to emergency messages 950 to the PD 120. The PD may accept the request and sends a response to subscription information with multicast address information 955 to the CD 130. The multicast address information sent may indicate where the emergency alert messages are sent. The multicast address information may include one or more of the following information:

Multicast group address

Multicast port

Protocol information

Additional multicast related information for emergency messages

The CD 130 may join multicast group for emergency alert messages 965 using the multicast address information. The input parameters when joining the multicast group may include zero or more of the following:

Companion Device ID

Companion Device Application ID

Companion Device Application Version

Optional: emergency message filtering criteria (e.g., geographic location filtering to provide emergency messages corresponding to only the specified location).

When an emergency message is received by the PD 120, it may provide emergency message 970 as a notification on the multicast group for emergency alert messages.

The emergency message may include one or more of the following:

Primary Device ID

Basic or initial contents of emergency alert message

Pointer (e.g. location information or URL) for additional information about the emergency alert message

The CD 130 that has joined the multicast group for emergency alert messages may receive the emergency alert messages from the multicast group. The emergency message may be provided as a notification message.

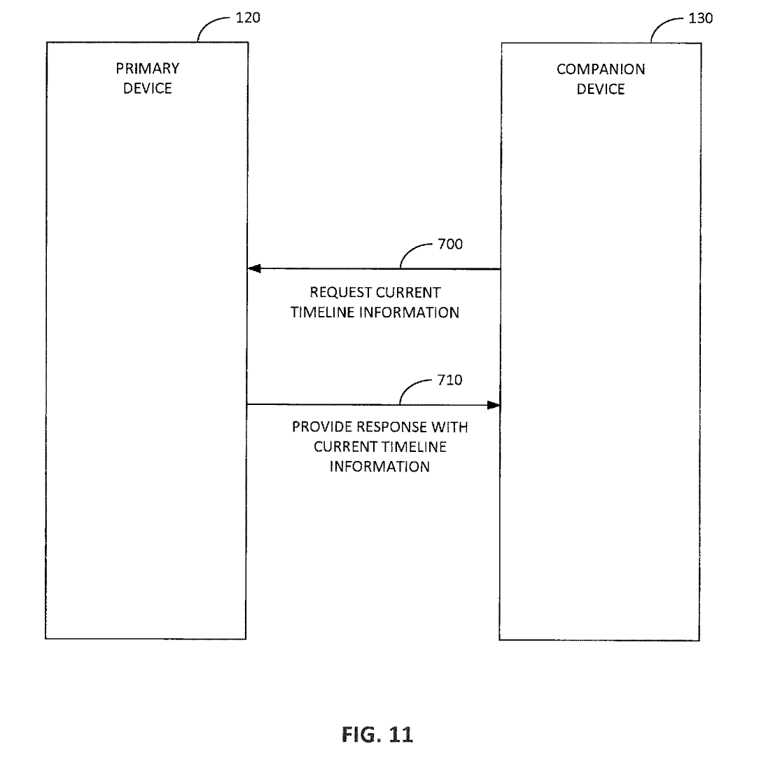

Referring to FIG. 11, in an example it is desirable to include a single transaction request response technique to receive timeline location information by the CD 130 from the PD 120. This facilitates the synchronization of the audiovisual content being displayed on the PD 120 and the CD 130.

For example the CD 130 may request current timeline information 700 from the PD 120. This may be invoked at any time when needed by the application. The input parameters may include one or more of the following:

Companion Device ID

Companion Device Application ID

Companion Device Application Version

The URL and/or the ID for which the current timeline information is requested or current show being viewed.

For example the PD 120 may provide response with the current timeline information 710 to the CD 130. This may be preferably sent upon receiving the request for the current timeline information. The response parameters may include one or more of the following:

Primary device ID

Current timeline location information for the requested URL and/or program ID.

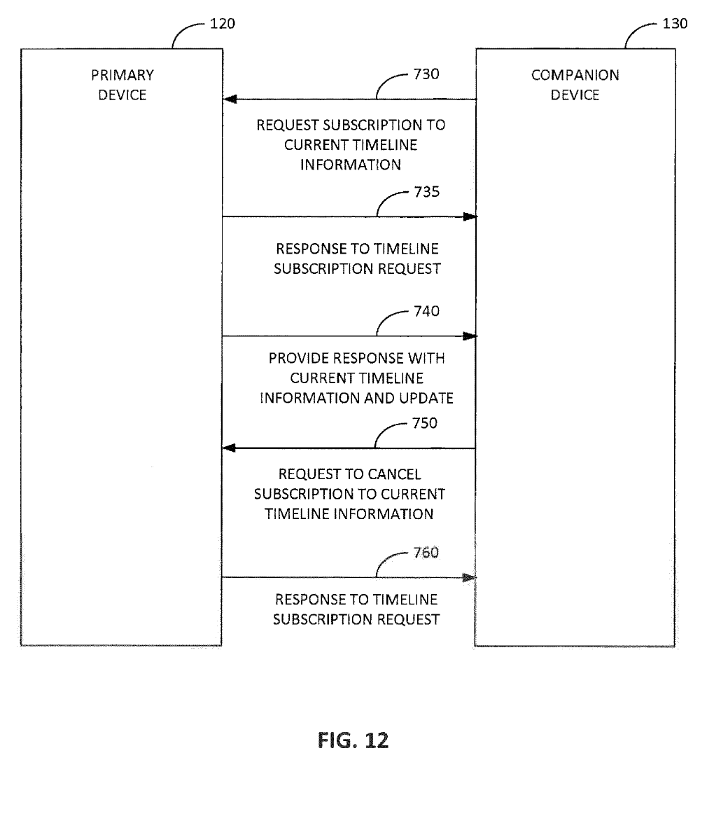

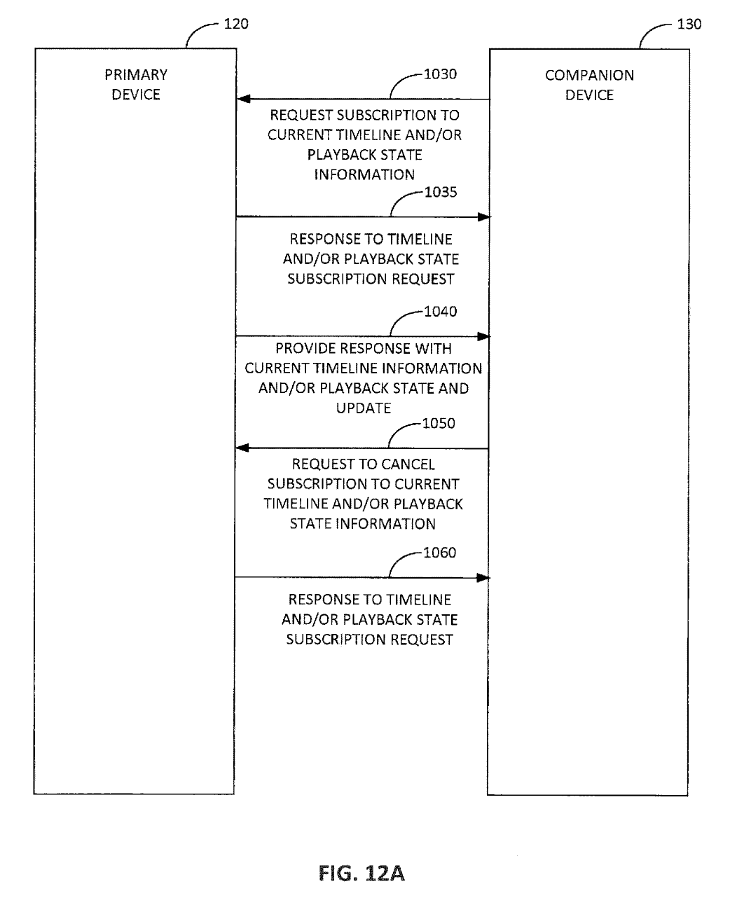

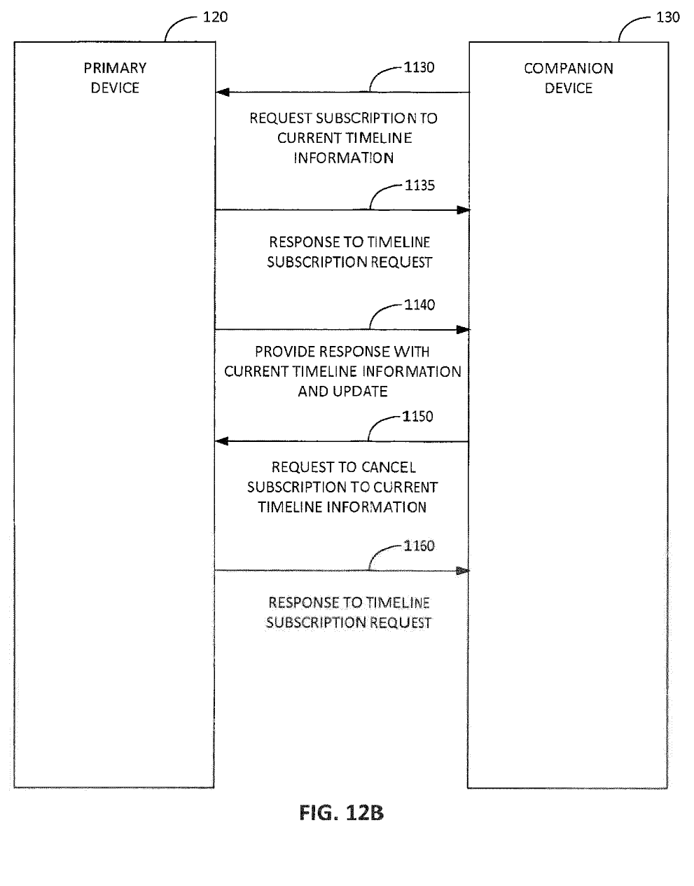

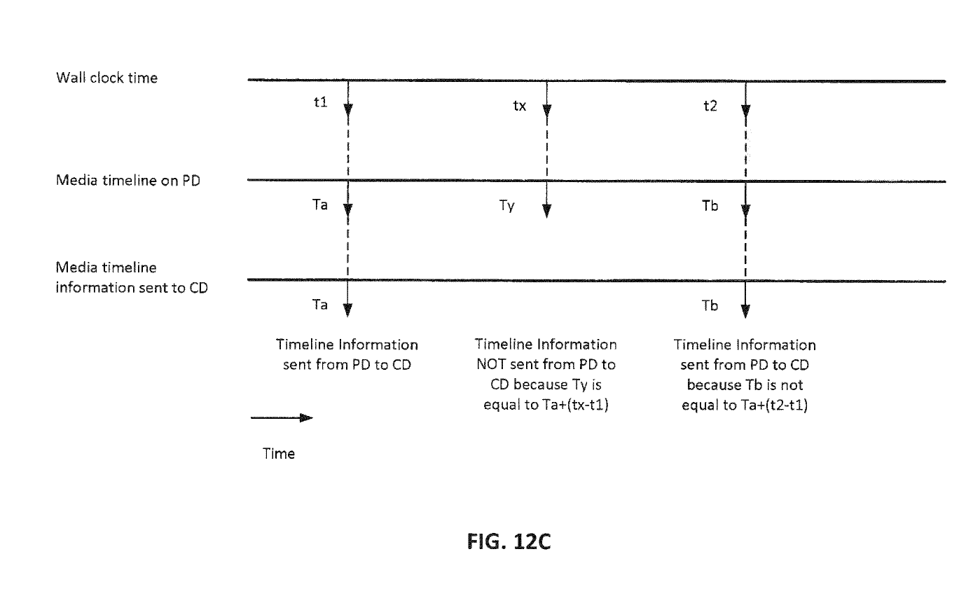

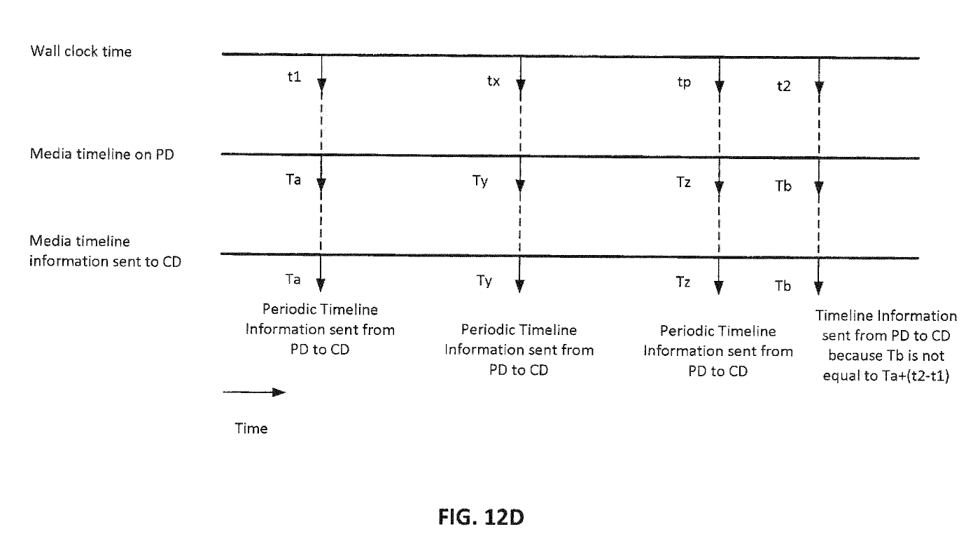

Referring to FIG. 12, in an example it is desirable to include a subscription request response technique to receive timeline information by the CD 130 from the PD 120. This facilitates the synchronization of the audiovisual content being displayed on the PD 120 and the CD 130.

For example the CD 130 may request subscription to current timeline information 730 to the PD 120. This may be invoked at any time when needed by the application. The input parameters may include one or more of the following:

Companion Device ID

Companion Device Application ID

Companion Device Application Version

The URL and/or the ID for which the current timeline information is requested or current show being viewed

Timeline subscription callback URL information

In response, the PD 120 may send a response to timeline subscription request 735 to the CD 130. The response parameters may include one or more of the following:

Primary device ID

Timeline subscription ID.

The timeline subscription ID may be used to uniquely identify this particular timeline subscription. Thus assigning a timeline subscription ID for each timeline subscription is preferred. This can allow a CD to request multiple timeline information from PD at the same time. It can also allow different CDs to request information about different timelines from different PDs.

For example the PD 120 may provide response with current timeline information and update 740 as a notification to the CD 130 on a regular basis. This may be invoked at any time to convey the current timeline information. The response parameters may include one or more of the following:

Primary device ID

Current timeline location information for the requested URL and/or program ID.

URL and/or program ID

The CD 130 may cease receiving the subscription timeline information after a predetermined period of time and/or sending a request to cancel the subscription to current timeline information 750 to the PD 120. The request to cancel the subscription to current timeline information 750 may include the subscription ID to uniquely identify the timeline subscription being cancelled. The PD may send a response to timeline subscription request 760 upon receiving a request to cancel the subscription indicating success or failure.

A similar request to cancel the subscription to current timeline information 750 and response to timeline subscription request 760 may be exchanged between the PD and the CD to renew the timeline subscription. In this case the request may include the timeline subscription Id to uniquely identify the timeline subscription being renewed.

Referring to FIG. 12A, in an example it is desirable to include a subscription request response technique to receive timeline and/or media playback state information by the CD 130 from the PD 120. This facilitates the synchronization of the audiovisual content being displayed on the PD 120 and the CD 130.

For example the CD 130 may request subscription to current timeline and/or playback state information PD 1030 on PD 120. This may be invoked at any time when needed by the application. The input parameters may include one or more of the following:

Companion Device ID

Companion Device Application ID

Companion Device Application Version

The URL and/or the ID for which the current timeline and/or current media playback information is requested or for the current show being viewed

Timeline and playback state subscription callback URL information

Optional: filter (send only media timeline information or send only media playback state information or send both media timeline and media playback state information)

Optional: Desired frequency at which to receive the notification about media timeline and/or media playback state information

The PD 120 may send a response to CD 130 timeline and/or playback state subscription request 1035 to CD 130. The response parameters may include one or more of the following:

Primary device ID

Timeline and/or playback state subscription ID

Subscription duration

The Timeline and/or playback state subscription ID

may be used to uniquely identify this particular subscription. Thus assigning a timeline and/or playback state subscription ID for each timeline and/or playback state subscription is preferred. This can allow a CD to request multiple timeline and playback state information from PD at the same time. It can also allow different CDs to request information about different timelines and playback states from different PDs.

For example the PD 120 may provide response with the current timeline and/or playback state information and update 1040 as a notification CD 130 on a regular basis to the CD 130. This may be invoked at any time to convey the current timeline and/or media playback state information. The response parameters may include one or more of the following:

Primary device ID

### Subscription ID

Current timeline location information for the requested Subscription ID.

Current media playback state information for the Subscription ID. This media playback state may include, for example, playing, paused, stopped, fast forward, speed of fast forward, fast backward, speed of fast backward, and buffering.

The CD 130 may cease receiving the subscription timeline and/or media playback state information after a predetermined period of time and/or by sending a request to cancel the subscription to current timeline and/or playback state information 1050 to the PD 120. The PD may send a response to timeline and/or playback state subscription request 1060 upon receiving a request to cancel the subscription indicating success or failure.

A similar request to cancel the subscription to current timeline and/or playback state information 1050 and response to timeline and/or playback state subscription request 1060 may be exchanged between the PD and the CD to renew the timeline and/or media playback state subscription. In this case the request may include the timeline and/or media playback state subscription ID to uniquely identify the timeline and/or media playback state subscription being renewed.

Referring to FIG. 12B, in an example it is desirable to include a subscription request response technique to receive timeline information by the CD 130 from the PD 120. This facilitates the synchronization of the audiovisual content being displayed on the PD 120 and the CD 130.

For example the CD 130 may request subscription to current timeline information 1130 to the PD 120. This may be invoked at any time when needed by the application. The input parameters may include one or more of the following:

Companion Device ID

Companion Device Application ID

Companion Device Application Version

The URL and/or the ID for which the current timeline information is requested or for the current show being viewed

Timeline subscription callback URL information

The PD 120 may send a response to timeline subscription request 1135 to the CD 130 in response to receiving the timeline subscription request. The response parameters may include one or more of the following:

Primary device ID

Timeline subscription ID.

The timeline subscription ID may be used to uniquely identify this particular timeline subscription. Thus assigning a timeline subscription ID for each timeline subscription is preferred. This can allow a CD to request multiple timeline information from PD at the same time. It can also allow different CDs to request information about different timelines from different PDs.

For example the PD 120 may provide response with current timeline information and update 1140 to the CD 130 on a regular basis. Thus the current timeline information may be sent periodically. Additionally the timeline information may be sent from PD 120 to CD 130 whenever the timeline on the PD changes nonlinearly. This non-linear timeline change based notification is described later with respect to FIG. 12C and FIG. 12D. This may be invoked at any time to convey the current timeline information. The response parameters may include one or more of the following:

Primary device ID

Current timeline location information for the requested URL and/or program ID.

URL and/or program ID

The CD 130 may cease receiving the subscription timeline information after a predetermined period of time and/or by sending a request to cancel the subscription to the current timeline information 1150 to the PD 120. The request to cancel the subscription to the current timeline information 1150 may include the subscription ID to uniquely identify the timeline subscription being cancelled. The PD may send a response to the timeline subscription request 1160 upon receiving a request to cancel the subscription indicating success or failure.

A similar request to cancel the subscription to current timeline information 1150 and response to the timeline subscription request 1160 may be exchanged between the PD and the CD to renew the timeline subscription. In this case the request may include the timeline subscription ID to uniquely identify the timeline subscription being renewed.

An example media timeline information service from primary device to companion device is described further below.

A companion device may request media timeline from a primary device by sending a request and/or subscription request by HTTP, WebSocket, or another suitable protocol. The primary device that has accepted a subscription request from a companion device may send a notification response with media timeline information to the companion device. A primary device that is responding to a companion device request for current media timeline information may send a response with media timeline information to the companion device. The media timeline information from primary device to companion device may contain information shown in the following table:

| Element | | |
|---|---|---|
| Name | Cardinality | Description |
| MessageBody | 1 | Message body for media timeline |
| | | information |
| absoluteTime | 1 | Contains the current coordinated |
| | | universal time (UTC) time. |
| mediaTime | 1 | Contains the media time at the |
| | | current UTC time specified by the |
| | | absoluteTime element. |

where Coordinated Universal Time or Universal Time Coordinated is abbreviated as UTC and denotes a time standard.

In an example the media timeline information from primary device to companion device is JSON formatted and the MessageBody conforms to JSON schema shown in FIG. 33. In a further example absoluteTime and mediaTime represent time information but formatted as different data types. For example absoluteTime is of the data type string further formatted as “date-time” where as mediaTime is of the data type string in the JSON schema in FIG. 33.

The non-linear timeline change based notification is described with respect to FIG. 12C and FIG. 12D. A non-linear timeline change may be detected when during certain wall-clock time period the media timeline changes by a duration different than the wall-clock time duration. As an example if timeline information was communicated by primary device (PD) to companion device (CD) at wall-clock time t1, when the media timeline communicated was Ta. Then at a subsequent wall-clock time t2 (with t2>=t1) if the media timeline information Tb is such that Tb is not equal to (or approximately) equal to Ta+(t2−t1) or is not equal to Ta−(t2−t1) or is not equal to Ta+x*(t2−t1) where x is a real number then the media timeline information Tb may be communicated from PD to CD at wall-clock time t2. These scenarios are illustrated further in FIG. 12C and FIG. 12D.

In FIG. 12C PD after sending the media timeline information Ta to CD for the first time, does not send media timeline information to CD unless non-linear timeline change happens. Thus at wall-clock time tx, when the media timeline information on PD is equal to Ty, since Ty is equal to Ta+(tx−t1), the media timeline information Ty is not sent from PD to CD. This is because in this case a clock running on CD could automatically derive the value Tb. At wall-clock time t2, when the media timeline information on PD is equal to Tb, since Tb is not equal to Ta+(t2−t1), the media timeline information Tb is sent from PD to CD.

In FIG. 12D in addition to sending the non-linear timeline change event information from PD to CD; timeline information is also sent periodically from PD to CD. Thus periodically at wall-clock time t1, tx, tp respectively the media timeline information Ta, Ty, Tz respectively is sent from PD to CD. At wall-clock time t2, when the media timeline information on PD is equal to Tb, since Tb is not equal to Ta+(t2−t1), the media timeline information Tb is sent from PD to CD. It should be also noted that Tb is not equal to Tz+(t2−tp) and Tb is also not equal to Ty+(t2−tx).

In one example of the non-linear timeline change event, the timeline information is communicated from PD to CD when a program or show completes playback on PD and a new program/show playback starts. Another example is when a service or channel change occurs on PD.

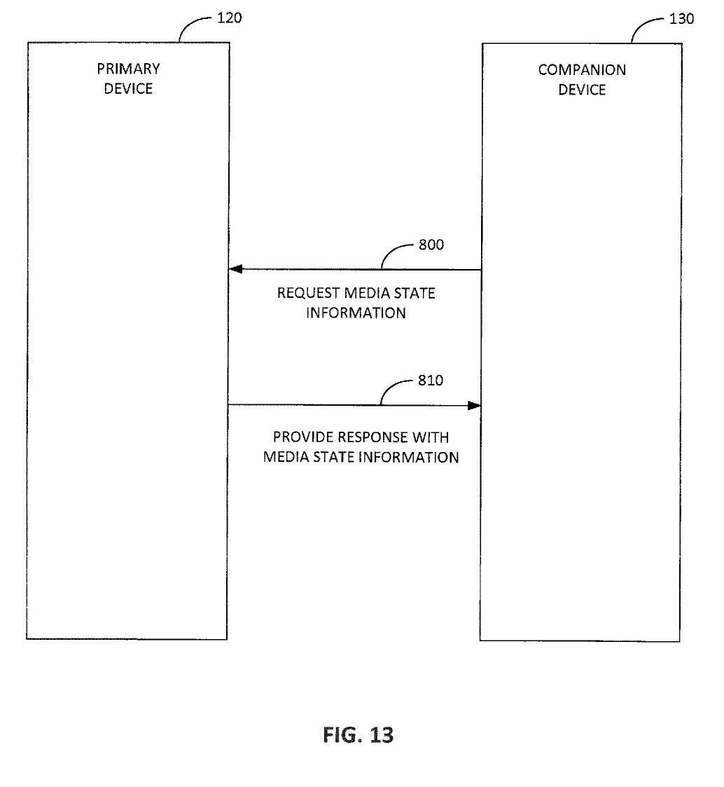

Referring to FIG. 13, in an example it is desirable to convey the media playback state of the media (service or program or show or segment) being played back on the PD 120 to the CD 130. This information is especially useful for the CD 130 if it desires to stay in synchronization with the PD 120. This facilitates the synchronization of the audiovisual content being displayed on the PD 120 and the CD 130.

For example the CD 130 may make a request to the PD 120 to receive the media state information 800. This may be invoked at any time when needed by the application. The input parameters may include one or more of the following:

Companion Device ID

Companion Device Application ID

Companion Device Application Version

The URL and/or the ID for which the media playback state is requested.

For example the PD 120 may provide a response with media state information 810 to the CD 130. This may be preferably sent upon receiving the request for the media state information. The response parameters may include one or more of the following:

Primary device ID

Current media playback state information for the requested URL or ID. This current media playback state may include, for example, playing, paused, stopped, fast forward, speed of fast forward, fast backward, speed of fast backward, and buffering.

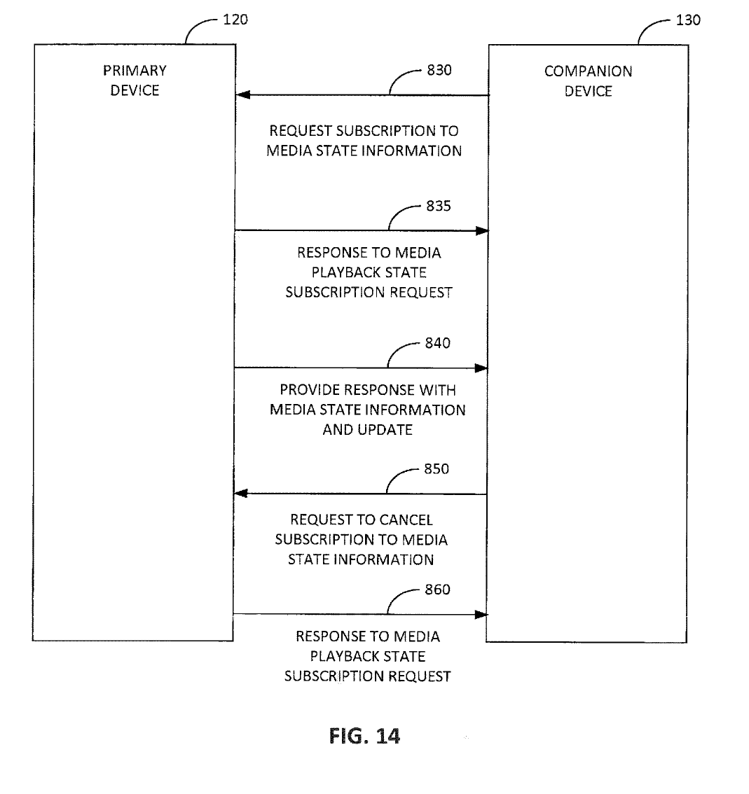

Referring to FIG. 14, in an example it is desirable to include a subscription request response technique to receive the media state information by the CD 130 from the PD 120. This facilitates the synchronization of the audiovisual content being displayed on the PD 120 and the CD 130.

For example the CD 130 may make a request to the PD 120 to subscribe to the media (playback) state information 830. This may be invoked at any time when needed by the application. The input parameters may include one or more of the following:

Companion Device ID

Companion Device Application ID

Companion Device Application Version

The URL and/or the ID for which the media playback state is requested

Media state subscription callback URL information

The PD 120 may send a response to the CD 130 in response to receiving the media playback state subscription response. This response to media playback state subscription request may be 835. The response parameters may include one or more of the following:

Primary device ID

Media playback state subscription ID.

The media playback state subscription ID may be used to uniquely identify this particular media playback state subscription. Thus assigning a media playback state subscription ID for each media playback state subscription is preferred. This can allow a CD to request multiple media playback state information from the PD at the same time. It can also allow different CDs to request information about different media playback states from different PDs.

For example the PD 120 may send a notification to the CD 130 with the current media playback state information that is updated on a regular basis. Thus PD 120 may provide response with media state information and update 840 to CD 130. This may be invoked at any time to convey the media playback state information. In an example the notification may be sent every time the media playback state changes. For example if the viewer pauses the presentation on the PD. Then a media playback state notification indicating the “Paused” state will be sent from the PD to the secondary device. Then later when the viewer resumes play on the PD a media playback state notification indicating the “Playing” state will be sent from the PD to the secondary device. This can allow the CD to playback media synchronized with the PD. For example a CD may automatically change its own media playback state when it receives a notification message indicating the change in the media playback state of the PD. Thus the response parameters may include one or more of the following:

Primary device ID

Media state subscription ID information for the requested URL and/or program ID

Current media playback state information for the subscription ID. This may include, for example, playing, paused, stopped, fast forward, speed of fast forward, fast backward, speed of fast backward, and buffering.

The CD 130 may cease receiving the media state subscription information after a predetermined period of time and/or sending a request to cancel the subscription to media state information 850 to the PD 120. The PD may send a response to media playback state subscription request 860 upon receiving a request to cancel the subscription indicating success or failure.

A similar request response as 850 and 860 may be exchanged between the PD and the CD to renew the media playback state subscription. In this case the request preferably includes the media playback state subscription ID to uniquely identify the media playback state subscription being renewed.

In an example, there may be multiple audiovisual content being displayed each having their own timeline, which is managed by the CD. In this manner, the CD can simultaneously display more than one audiovisual content and/or switch between different audiovisual content, while being in synchronization with the corresponding PD. In addition, by subscribing to the media playback state information, the PD 120 may notify the media playback state to the CD 130 when events occur, such as for example, stopping the audiovisual content, pausing the audiovisual content, fast forwarding the audiovisual content, rewinding the audiovisual content, skipping forward and/or backward in the audiovisual content, or otherwise.

As previously described for example in relation with FIG. 5 and FIG. 6, the CD 130 may be made discoverable from the PD 120.

For example the CD 130 may advertise or announce a message to help its discovery by the PD 120. This may be invoked at any time when needed by the application, such as starting the application and/or joining the network using a multicast message, or when the PD sends a multicast search request for device or service types of the CD (for example a unicast message from CD). The input parameters may include one or more of the following:

Companion Device ID

Companion Device Application ID

Companion Device Application Version

Human readable name of companion device

Companion device services (service types) supported

For example the PD 120 may send a multicast message to the network to discover the CD 130. Thus the PD may send a multicast search message looking for device type or service type of CD(s). The search message parameters may include one or more of the following:

Primary device ID

Primary Device type

Primary Device version

Human readable name of primary device

CD type and/or CD service type being looked up

It is to be understood that the system may be reconfigured, as desired. It is to be understood that the system may include additional elements and/or fewer elements, as desired. It is to be understood that some of the message sequence may be altered such that a message 1 shown to be sent before message 2 may instead be sent after message 2.

PD and CD exchange various messages between them. The messages may be exchanged between PD and CD for different services. For example messages may be exchanged between PD and CD for emergency alert information to be communicated from PD to CD. Similarly messages may be exchanged between PD and CD for media playback state information to be communicated from PD to CD. Other services for which messages may be exchanged between PD and CD include but are not limited to content identification service, electronic service guide information service, media timeline checkpoints information service or any generic PD application to CD application service. In another example instead of the term service some other term may be used for each of these individual collection of messages serving as specific type of information.

Additionally for a particular type of service there may be one or more instance of the service running concurrently on PD and CD. As an example there may be two instances of a media playback state information service exchanging messages between one PD and one CD simultaneously.

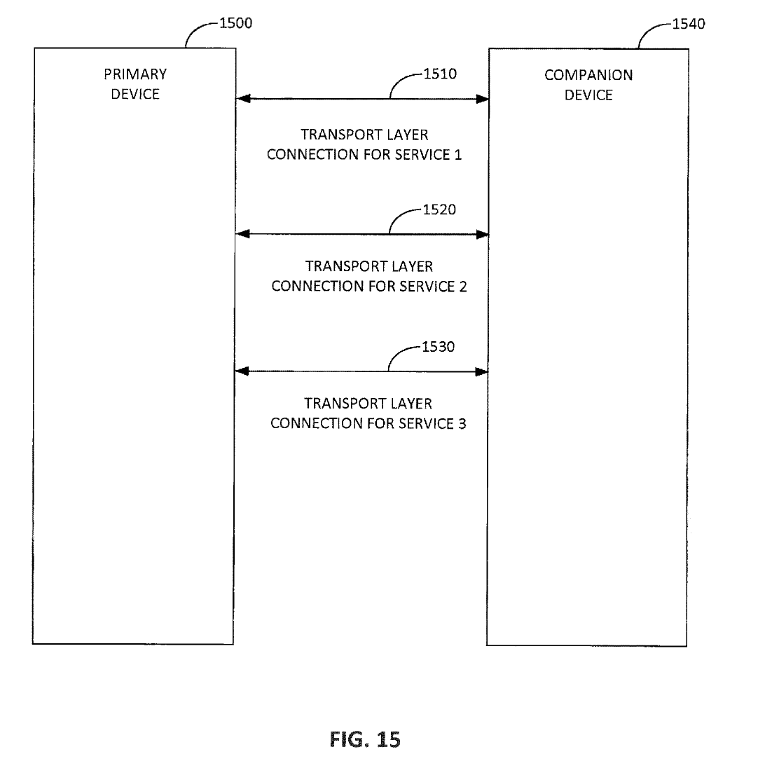

As shown in FIG. 15 an existing mechanism for message communication between a PD 1500 and CD 1540 for multiple services is to use a separate transport layer connection for each service. Thus in FIG. 15 service1 uses transport layer connection 1510, service 2 uses transport layer connection 1520, and service 3 uses transport layer connection 1530. A transport layer connection may be a WebSocket connection as defined in Internet Engineering Task Force (IETF) Request For Comment (RFC) 6455 as specified in http://www.ietf.org/rfc/rfc6455.txt. In other cases the transport layer connection may be a TCP/IP or some other reliable or unreliable connection between two end points. Using separate connections for each service may be burdensome as each device (e.g. PD and CD) needs to manage multiple connections. For a CD which often may be a smartphone and/or a tablet device, managing multiple connections for multiple services may result in consuming more energy and/or more memory.

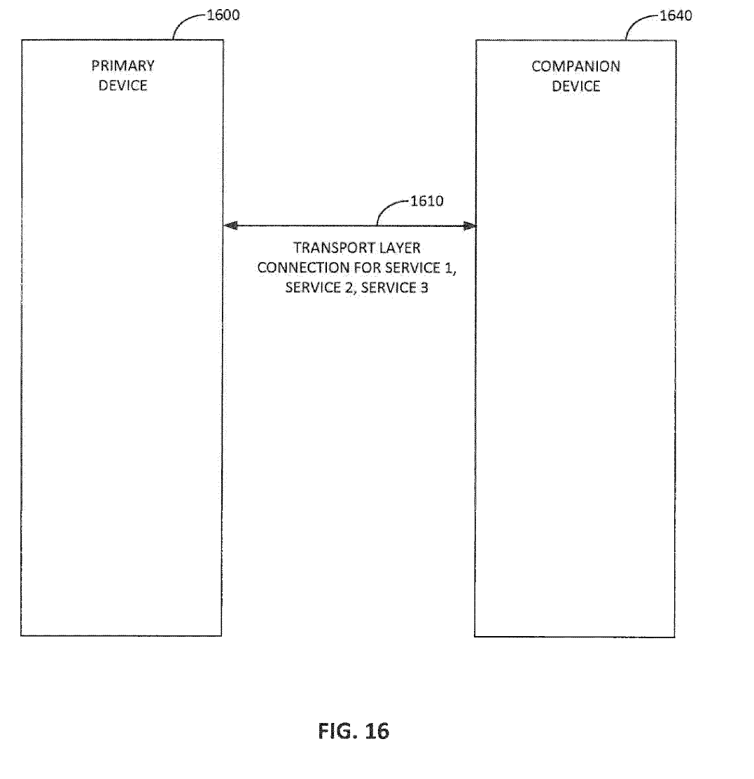

In comparison with FIG. 15, FIG. 16 shows a message communication between a PD 1600 and a CD 1640 for multiple services using a single transport layer connection. Thus in FIG. 16 a single transport layer connection 1610 is used for communicating messages for service 1, service 2, and service 3. This may be facilitated by a message structure as described herein. With respect to FIG. 16, a transport layer connection may be a WebSocket connection as defined in IETF RFC 6455 as specified in http://www.ietf.org/rfc/rfc6455.txt. In other cases the transport layer connection may be a TCP/IP or some other reliable or unreliable connection between two end points. Using a single connection for multiple services may result in consuming less energy and/or less memory for the PD and/or CD.

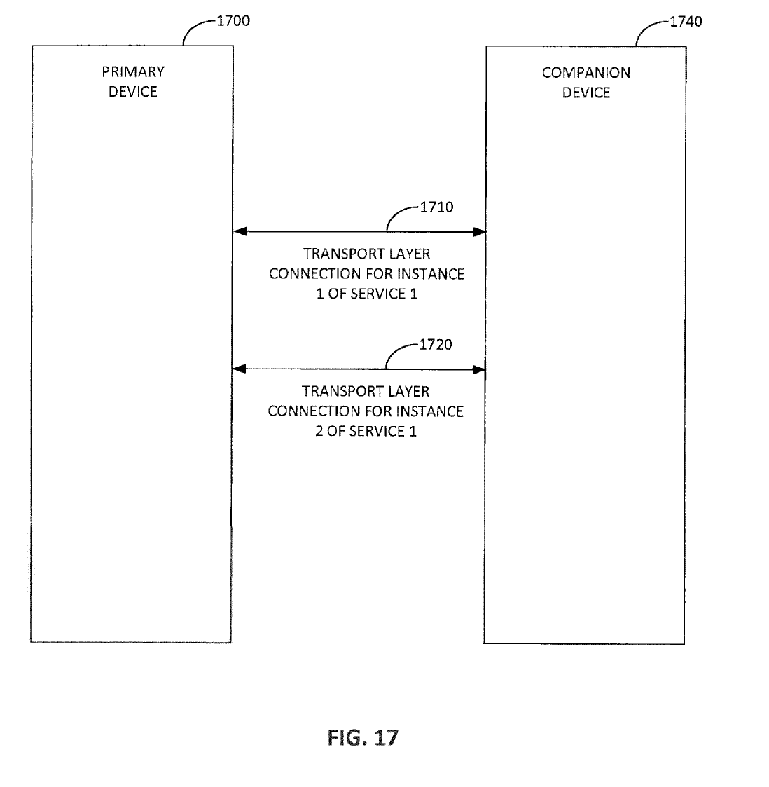

As shown in FIG. 17, one mechanism for message communication between a PD 1700 and a CD 1740 for multiple instances of the same service is to use a separate transport layer connection for each service. Thus in FIG. 17, instance1 of service1 uses transport layer connection 1710, instance 2 of service 1 uses transport layer connection 1720. A transport layer connection may be a WebSocket connection as defined in IETF RFC 6455 as specified in http://www.ietf.org/rfc/rfc6455.txt. In other cases the transport layer connection may be a Transmission Control Protocol (TCP)/IP or some other reliable or unreliable connection between two end points. Using separate connections for multiple instances of the same service may be burdensome as each device (e.g. PD and CD) needs to manage multiple connections. For a CD which often may be a smartphone and/or a tablet device, managing multiple connections for multiple instances of a service may result in consuming more energy and/or more memory.

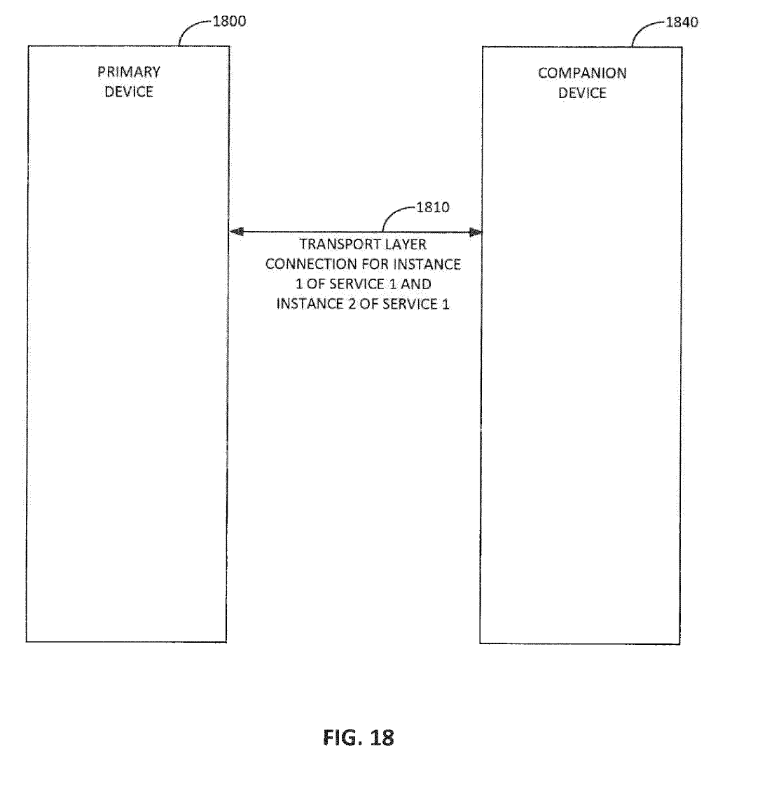

In comparison with FIG. 17, FIG. 18 shows a message communication between a PD 1800 and a CD 1840 for multiple instances of the same service using a single transport layer connection. Thus in FIG. 18 a single transport layer connection 1810 is used for communicating messages for instance1 of service 1, and instance2 of service 1. This is facilitated by a message structure as described herein. With respect to FIG. 18, a transport layer connection may be a WebSocket connection as defined in IETF RFC 6455 as specified in http://www.ietf.org/rfc/rfc6455.txt. In other cases the transport layer connection may be a TCP/IP or some other reliable or unreliable connection between two end points. Using a single connection for multiple instances of a service may result in consuming less energy and/or less memory for the PD and/or CD.

The messages may be exchanged between PD and CD for various services and for difference instances of the same service using a common message structure as defined further.

A few examples for the manner in which the defined PD to CD message structure data fields may be used are described next.

In one example the message structure provides the structure or format within which any message sent between a PD and CD is enclosed and communicated.

In one example a message between PD and CD enclosed in a message structure may be communicated from PD to CD or from CD to PD or from PD to another entity or from CD to another entity. In one example this message may be stored or archived. In one example the message structure defined with various data fields may be exchanged from one logical entity and another logical entity. In one case each of these entities may be a Television set or a receiver or a set-top box. In another example one or more of the entities may be a smartphone or a tablet device. In some case the logical entities may be same physical entity. In one example a PD may be a television or a receiver or a set-top box. In another example a CD may be a smartphone or a tablet.

In an example, the message structure for messages exchanged between two logical entities with various data fields may require that the structure of the message and message body exchanged conform to a defined schema and/or structure defined. Some examples of schema and/or structure are described further.

In one case the exchange of the message enclosed in a message structure defined above with various data fields may take place over network. In an example a set of defined APIs may be used to exchange the message in a message structure.

In an example the message including message structure defined above with various data fields may be serialized. In one case the order of the fields in the message structure defined above with various data fields may be maintained in the order specified above. In other cases the order may be changed with respect to each other.

It should be noted that the term “message structure” may instead be called “message envelope” or “message format” or “message elements” or “message skeleton” or other similar terms.

Further details regarding communication message structure for PD to CD message communication are described next. Various message structure data fields are described. Syntax and semantics is described for the message structure fields. The message structure allows carrying any communication messages in the body of the message structure. XML, JSON and bitstream (binary) format is described for the message structure.

Elements of message structure are described next.

Three categories of message structures are defined. Depending upon the message type (identified by the PDCDMessageType element, the rest of the message structure contains different type of message elements).

Elements belonging to the common part of message structure is shown in Table 1.1.

If the common part of message structure elements indicates a message of “request message type” then additionally the elements corresponding to Table 1.2 are included after the common message structure elements of Table 1.1.

If the common part of message structure elements indicates a message of “response message type” then additionally the elements corresponding to Table 1.3 are included after the common message structure elements of Table 1.1.

If the common part of message structure elements indicates a message of “notification message type” then additionally the elements corresponding to Table 1.4 are included after the common message structure elements of Table 1.1.

Table 1.1 shows common message structure elements, their cardinality, the data type used for the elements and their semantic description.

TABLE 1.1
Common Message structure elements

| Element | | Data | |
|---|---|---|---|
| Name | Cardinality | type | Description |
| PDCDMessageVersion | 1 | Unsigned | Version of the Message structure. The upper 6 bits shall |
| | | Integer | indicate major version and lower two bits shall indicate |
| | | | minor version. The version of this message structure shall |
| | | | be 0x004 i.e. version 1.0. |
| | | | In another example different number of bits may be used |
| | | | for major version and for minor version. For example each |
| | | | of them may use 4 bits. |
| PDCDServiceID | 1 | Unsigned | The service identifier which uniquely identifies the PD-CD |
| | | Integer | service. The service identifier values are as defined in |
| | | | Table 2. The PDCDServiceID field for messages defined |
| | | | in this version of this specification shall take values in the |
| | | | range 0-2, 16-18, 32-33 inclusive. PD and CD conforming |
| | | | to this version of this specification shall be capable of |
| | | | ignoring a message received with PDCDServiceID value |
| | | | other than 0-2, 16-18, 32-33. |
| PDCDServiceName | 1 | String | The service name or URI which uniquely identifies the |
| | | | PD-CD service. The enumerated service name values |
| | | | are as defined in Table 3. |
| | | | The PDCDServiceName field for messages defined in this |
| | | | version of this specification shall take values from one of |
| | | | the values {atsc3.services.eam.1, atsc3.services.esg.1, |
| | | | atsc3.services.ect.1, atsc3.services.mps.1, |
| | | | atsc3.services.mtc.1, atsc3.services.ata.1}. PD and CD |
| | | | conforming to this version of this specification shall be |
| | | | capable of ignoring a message received with |
| | | | PDCDServiceName other than the names defined in Table |
| | | | 3. |
| PDCDMessageType or | 1 | Unsigned | Identifies the type of message. The message identifier |
| PDCDOperationType | | Integer or | values for message types are as defined in Table 4. The |
| | | String | enumerated message types are as defined in Table 5. |
| | | | Allowed direction (from PD to CD or from CD to PD) for |
| | | | message types shall constrained to be as defined in the |
| | | | Table 4 and 5. |
| | | | Three categories of message structures are defined. |
| | | | This includes request message types, response message |
| | | | types and notification messages types. Depending upon |
| | | | the message type (identified by the PDCDMessageType |
| | | | element), the rest of the message structure contains |
| | | | different type of message elements. |

In some examples PDCDServiceName may instead be called PDCDFeatureName. In general any names other than those shown in this document may be used. Also instead of an element being signaled as an element, it may be signaled as an attribute of another element.

Table 1.1 shows additional message structure elements for request message types, their cardinality, the data type used for the elements and their semantic description. A request message type will include elements shown in Table 1.1 and Table 1.2.

TABLE 1.2
Additional Message structure elements for request message types

| Element | | Data | |
|---|---|---|---|
| Name | Cardinality | type | Description |
| PDCDSubID | 1 | String or | The subscription identifier for this message flow between |
| | | Unsigned | PD and CD. PDCDSubID is used to uniquely identify this |
| | | Integer | subscription between CD to the PD. |
| | | | When PDCDMessageType is 0 (Message from CD to PD to |
| | | | request a subscription), the PDCDSubID shall be set equal |
| | | | to 0. |

Table 1.3 shows additional message structure elements for response message types, their cardinality, the data type used for the elements and their semantic description. A response message type will include elements shown in Table 1.1 and Table 1.3.

TABLE 1.3
Additional Message structure elements for response message types

| Element | | Data | |
|---|---|---|---|
| Name | Cardinality | type | Description |
| PDCDSubID | 1 | String or | The subscription identifier for this subscription. |
| | | Unsigned | PDCDSubID is used to uniquely identify this |
| | | Integer | subscription between CD and PD. PDCDSubID shall |
| | | | not be equal to 0 in response message types. |
| PDCDRespCode | 1 | Unsigned | A success or failure status code for the corresponding |
| | | Integer or | request. |
| | | String | |
| PDCDSubDuration | 1 | Unsigned | Subscription duration. Indicates duration for which |
| | | Integer | subscription is active. |

In some examples the Message Structure for response message types may include an element indicating the subscription duration which indicates the duration for which the subscription is active.

Table 1.4 shows additional message structure elements for notification message types, their cardinality, the data type used for the elements and their semantic description. A notification message type will include elements shown in Table 1.1 and Table 1.4.

TABLE 1.4
Additional Message structure elements for notification message types

| Element | | Data | |
|---|---|---|---|
| Name | Cardinality | type | Description |
| PDCDSubID | 1 | String or | The subscription identifier for this subscription. |
| | | Unsigned | PDCDSubID is used to uniquely identify this |
| | | Integer | subscription between CD and PD. |
| PDCDMessageIDNumber | 1 | String or | Unique identifier for the message. Used for duplicate |
| | | Unsigned | detection. A message with a message ID value of mIDA |
| | | Integer | shall have at least one of its message field values |
| | | | different compared to a message with a message ID |
| | | | value of mIDB when mIDA is not equal to mIDB. |
| PDCDMessageSequenceNumber | 0..1 | Unsigned | Sequence number for the message. The sequence |
| | | Integer | number field shall be incremented by one for each new |
| | | | message. The sequence number shall wrap back to 0 |
| | | | when it reaches the maximum supported value. |
| PDCDMessageBodyLength | 1 | Unsigned | Length in bytes of the PDCDMessageBodyData |
| | | Integer | element. |
| PDCDMessageBodyData | 0..1 | Bytes | Message specific data elements. The syntax and |
| | | | semantics of the PDCDMessageBodyData is defined in |
| | | | individual messages of individual services. |
| PDCDMD5CheckSum | 0..1 | | Message Digest 5 (MD5) checksum for the entire |
| or CRC32 | | | message (or Cyclic Redundancy Check (CRC) for the |
| | | | entire message). |
| | | | Alternatively MD5 checksum for the field |
| | | | PDCDMessageBodyData (or CRC for the field |
| | | | PDCDMessageBodyData). |

Instead of breaking the multiple elements of the message structure into multiple tables as Table 1.1, 1.2, 1.3, 1.4, they could be represented in a single table as shown in Table 1. Table 1 shows message structure elements, their cardinality, the data type used for the elements and their semantic description. Certain message elements are included in certain message type categories. The column “Included in Message Category” in Table 1 indicates if a particular element is included in a certain message category. As mentioned previously three categories of message types are defined. This includes:

request message types,

response message types and

notification messages types.

Depending upon the message type (identified by the PDCDMessageType element), the rest of the message structure contains different type of message elements).

TABLE 1
Message structure elements

| | | | Included in | |
|---|---|---|---|---|
| Element | | Data | Message | |
| Name | Cardinality | type | category | Description |
| PDCDMessageVersion | 1 | Unsigned | All | Version of the Message structure. The upper 6 |
| | | Integer | | bits shall indicate major version and lower two bits |
| | | | | shall indicate minor version. The version of this |
| | | | | message structure shall be 0x004 i.e. version 1.0. |
| | | | | In another example different number of bits may |
| | | | | be used for major version and for minor version. |
| | | | | For example each of them may use 4 bits. |
| PDCDServiceID | 1 | Unsigned | All | The service identifier which uniquely identifies the |
| | | Integer | | PD-CD service. The service identifier values are |
| | | | | as defined in Table 2. The PDCDServiceID field |
| | | | | for messages defined in this version of this |
| | | | | specification shall take values in the range 0-2, |
| | | | | 16-18, 32-33, inclusive. PD and CD conforming to |
| | | | | this version of this specification shall be capable |
| | | | | of ignoring a message received with |
| | | | | PDCDServiceID value other than 0-2, 16-18, |
| | | | | 32-33. |
| PDCDServiceName | 1 | String | All | The service name or Uniform Resource Identifier |
| | | | | (URI) which uniquely identifies the PD-CD |
| | | | | service. The enumerated service name values are |
| | | | | as defined in Table 3. |
| | | | | The PDCDServiceName field for messages |
| | | | | defined in this version of this specification shall |
| | | | | take values from one of the values |
| | | | | {atsc3.services.eam.1, atsc3.services.esg.1, |
| | | | | atsc3.services.ect.1, atsc3.services.mps.1, |
| | | | | atsc3.services.mtc.1, atsc3.services.ata.1}. PD |
| | | | | and CD conforming to this version of this |
| | | | | specification shall be capable of ignoring a |
| | | | | message received with PDCDServiceName other |
| | | | | than the names defined in Table 3. |
| PDCDMessageType | 1 | Unsigned | All | Identifies the type of message. The message |
| Or | | Integer or | | identifier values for message types are as defined |
| PDCDOperationType | | String | | in Table 4. The enumerated message types are |
| | | | | as defined in Table 5. Allowed direction (from |
| | | | | PD to CD or from CD to PD) for message types |
| | | | | shall constrained to be as defined in the Table 4 |
| | | | | and 5. Three categories of message structures |
| | | | | are defined. This includes request message |
| | | | | types, response message types and notification |
| | | | | messages types. Depending upon the message |
| | | | | type (identified by the PDCDMessageType |
| | | | | element), the rest of the message structure |
| | | | | contains different type of message elements. |
| PDCDSubID | 1 | String or | Request | The subscription identifier for this message flow |
| | | Unsigned | Message | between PD and CD. PDCDSubID is used to |
| | | Integer | types, | uniquely identify this subscription between CD |
| | | | Response | and PD. |
| | | | Message | When PDCDMessageType is 0 (Message from |
| | | | types | CD to PD to request a subscription), the |
| | | | | PDCDSubID shall be set equal to 0. |
| PDCDRespCode | 1 | Unsigned | Response | A success or failure status code for the |
| | | Integer or | Message | corresponding request. |
| | | String | types | |
| PDCDSubDuration | 1 | Unsigned | Response | Subscription duration. Indicates duration for which |
| | | Integer | Message | subscription is active. |
| | | | Types | |
| PDCDMessageIDNumber | 1 | String or | Notification | Unique identifier for the message. Used for |
| | | Unsigned | Message | duplicate detection. A message with a message |
| | | Integer | Types | ID value of mIDA shall have at least one of its |
| | | | | message field values different compared to a |
| | | | | message with a message ID value of mIDB when |
| | | | | mIDA is not equal to mIDB. |
| PDCDMessageSequenceNumber | 0..1 | Unsigned | Notification | Sequence number for the message. The |
| | | Integer | Message | sequence number field shall be incremented by |
| | | | Types | one for each new message. The sequence |
| | | | | number shall wrap back to 0 when it reaches the |
| | | | | maximum supported value. |
| PDCDMessageBodyLength | 1 | Unsigned | Notification | Length in bytes of the PDCDMessageBodyData |
| | | Integer | Message | element. |
| | | | Types | |
| PDCDMessageBodyData | 0..1 | Bytes | Notification | Message specific data elements. The syntax and |
| | | | Message | semantics of the PDCDMessageBodyData is |
| | | | Types | defined in individual messages of individual |
| | | | | services. |
| PDCDMD5CheckSum | 0..1 | | Notification | MD5 checksum for the entire message (or CRC |
| or CRC32 | | | Message | for the entire message). |
| | | | Types | Alternatively MD5 checksum for the field |
| | | | | PDCDMessageBodyData (or CRC for the field |
| | | | | PDCDMessageBodyData). |

Table 2 shows PD-CD Service ID (PDCDServiceID element) values and the service between PD and CD that the values represent shown in the “Description” column in Table 2.

TABLE 2
PD-CD Service Identifier values

| PDCDServiceID | Description |
|---|---|
| 0 | Emergency Alert Service |
| 1 | Electronic Service Guide |
| 2 | Content Identification |
| 3 | Media Playback State |
| 4 | Media Timeline Checkpoints |
| 5 | PD Application (App) to CD App communication |
| 6-254 | Reserved |
| 255 | Unknown |

Table 3 shows PD-CD Service ID (PDCDServiceID element) enumeration values and the service between PD and CD that the values represent. The difference between Table 2 and Table 3 is as follows. In Table 2 an unsigned integer value is used to identify and represent a service. In Table 3 a enumerated string value is used to identify and represent a service.

TABLE 3
Service enumeration values

| PDCDServiceName | Description |
|---|---|
| atsc3.services.eam.1 | Emergency Alert Service |
| atsc3.services.esg.1 | Electronic Service Guide |
| atsc3.services.ect.1 | Content Identification |
| atsc3.services.mps.1 | Media Playback State |
| atsc3.services.mtc.1 | Media Timeline Checkpoints |
| atsc3.services.ata.1 | PD App to CD App communication |
| atsc3.services.rsv.1 | Reserved |
| Atsc3.services.unk.1 | Unknown |

Table 21 shows a combined table which lists PD-CD Service ID (PDCDServiceID element) integer and enumerated string values and the service between PD and CD that the values represent. The tables 2, 3, and 21 are considered equivalent and each convey similar type of information.

TABLE 21
Service Enumeration and service ID values

| PDCDServiceName | PDCDServiceID | Description |
|---|---|---|
| atsc3.services.eam.1 | 0 | Emergency Alert Service |
| atsc3.services.esg.1 | 1 | Electronic Service Guide |
| atsc3.services.ect.1 | 2 | Content Identification |
| atsc3.services.mps.1 | 3 | Media Playback State |
| atsc3.services.mtc.1 | 4 | Media Timeline Checkpoints |
| atsc3.services.ata.1 | 5 | PD App to CD App communication |
| atsc3.services.rsv.1 | 6-254 | Reserved |
| Atsc3.services.unk.1 | 255 | Unknown |

Table 4 shows PD-CD Message Type (PDCDMessageType element) values and the description of the message type/operation type and allowed direction for the message type. Some of the message types could only be sent from PD to CD. Some message types could only be sent from CD to PD.

TABLE 4
Message type identifier values:

| | | |
|---|---|---|
| Message Type | | Allowed direction for |
| (PDCDMessageType) | Description | this message type |

Request Message Types

| | | |
|---|---|---|
| 0 | Message to request a subscription | From CD to PD |
| 1 | Message to cancel a subscription | From CD to PD |
| 2 | Message to renew a subscription | From CD to PD |
| 3-15 | Reserved Request message types from | From CD to PD |
| | the CD to the PD | |

Response Message Types

| | | |
|---|---|---|
| 16 | Response Message to the subscription | From PD to CD |
| | request | |
| 17 | Response Message to the cancel | From PD to CD |
| | request | |
| 18 | Response Message to the renew | From PD to CD |
| | request | |
| 19-31 | Reserved response message types | From PD to CD |
| | sent from the PD to the CD | |

Notification Message Types

| | | |
|---|---|---|
| 32 | Notification Message that is sent to | From PD to CD |
| | subscribers | |
| 33 | Subscriber's confirmation message of | From CD to PD |
| | received notification | |
| 34-63 | Reserved notification message types | From PD to CD |
| | sent from the PD to the CD | |

Misc. Message Types

| | | |
|---|---|---|
| 64-254 | Reserved | From PD to CD, |
| | | From CD to PD |
| 255 | Unknown | From PD to CD, |
| | | From CD to PD |

Table 5 shows PD-CD Message Type (PDCDMessageType element) enumerated values and the description of the message type or operation type and allowed direction for the message type. Some of the message types could only be sent from PD to CD. Some message types could only be sent from CD to PD.

TABLE 5
Message type enumeration and message ID values:

| | | |
|---|---|---|
| Message Type | | Allowed direction for |
| (PDCDMessageType) | Description | this message type |

Request Message Types

| | | |
|---|---|---|
| subscribe | Message to request a subscription | From CD to PD |
| cancel | Message to cancel a subscription | From CD to PD |
| renew | Message to renew a subscription | From CD to PD |
| request | Reserved Request message types from | From CD to PD |
| | the CD to the PD | |

Response Message Types

| | | |
|---|---|---|
| subscribed | Response Message to the subscription | From PD to CD |
| | request | |
| canceled | Response Message to the cancel | From PD to CD |
| | request | |
| renewed | Response Message to the renew | From PD to CD |
| | request | |
| response | Reserved response message types | From PD to CD |
| | sent from the PD to the CD | |

Notification Message Types

| | | |
|---|---|---|
| notify | Notification Message that is sent to | From PD to CD |
| | subscribers | |
| notified | Subscriber's confirmation message of | From CD to PD |
| | received notification | |
| genericnotify | Reserved notification message types | From PD to CD |
| | sent from the PD to the CD | |

Misc. Message Types

| | | |
|---|---|---|
| reserved | Reserved | From PD to CD, |
| | | From CD to PD |
| unknown | Unknown | From PD to CD, |
| | | From CD to PD |

Table 41 shows a combined table which lists PD-CD Message Type (PDCDMessageType element) integer and enumerated string values and the description of the message type or operation type and allowed direction for the message type. Some of the message types could only be sent from PD to CD. Some message types could only be sent from CD to PD. It should be noted that instead of the term “message type” the term “operation type” may be used. The Tables 4, 5, and 41 are considered equivalent and each convey similar type of information.

TABLE 41
Message type enumeration values:

| | | | |
|---|---|---|---|
| Message Type | | | |
| Enumeration | Message | | Allowed direction for |
| (PDCDMessageType) | Type ID | Description | this message type |

Request Message Types

| | | | |
|---|---|---|---|
| subscribe | 0 | Message to request a subscription | From CD to PD |
| cancel | 1 | Message to cancel a subscription | From CD to PD |
| renew | 2 | Message to renew a subscription | From CD to PD |
| request | 3-15 | Reserved Request message types from | From CD to PD |
| | | the CD to the PD | |

Response Message Types

| | | | |
|---|---|---|---|
| subscribed | 16 | Response Message to the subscription | From PD to CD |
| | | request | |
| canceled | 17 | Response Message to the cancel | From PD to CD |
| | | request | |
| renewed | 18 | Response Message to the renew | From PD to CD |
| | | request | |
| response | 19-31 | Reserved response message types | From PD to CD |
| | | sent from the PD to the CD | |

Notification Message Types

| | | | |
|---|---|---|---|
| notify | 32 | Notification Message that is sent to | From PD to CD |
| | | subscribers | |
| notified | 33 | Subscriber's confirmation message of | From CD to PD |
| | | received notification | |
| genericnotify | 34-63 | Reserved notification message types | From PD to CD |
| | | sent from the PD to the CD | |

Misc. Message Types

| | | |
|---|---|---|
| reserved | Reserved | From PD to CD, |
| | | From CD to PD |
| unknown | Unknown | From PD to CD, |
| | | From CD to PD |

The message “Subscriber's confirmation message of received notification” is shown in Table 4, Table 5 and Table 51 as belonging to “Notification Message Type”. It may instead be classified as response message type or request message type. Similarly some other messages may be classified as belonging to another message type category. Also in some examples some messages may be designated as belonging to multiple message type categories.

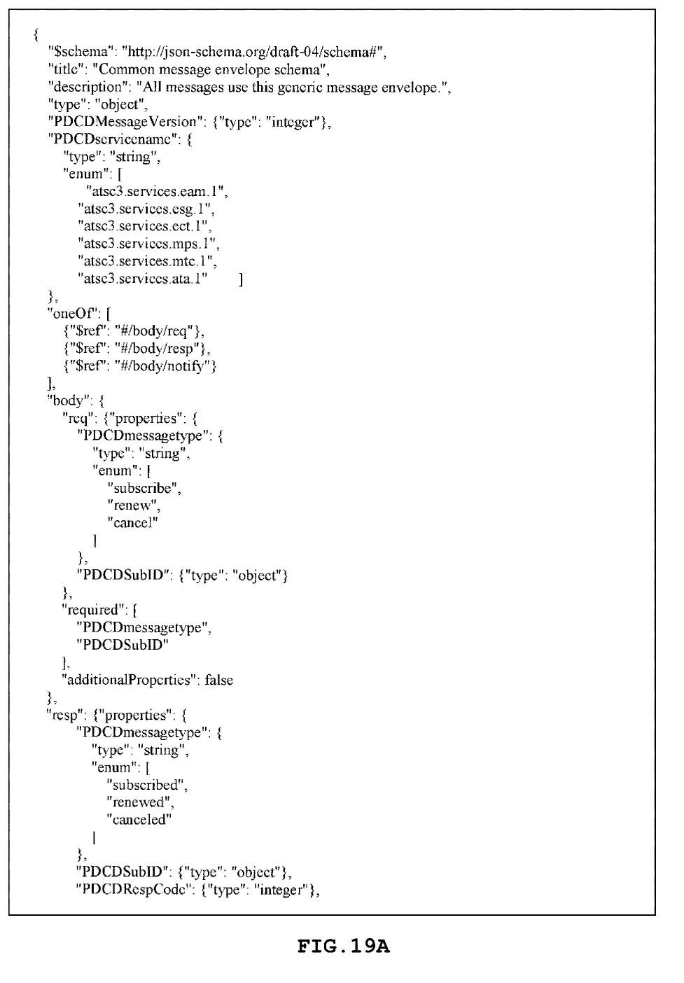

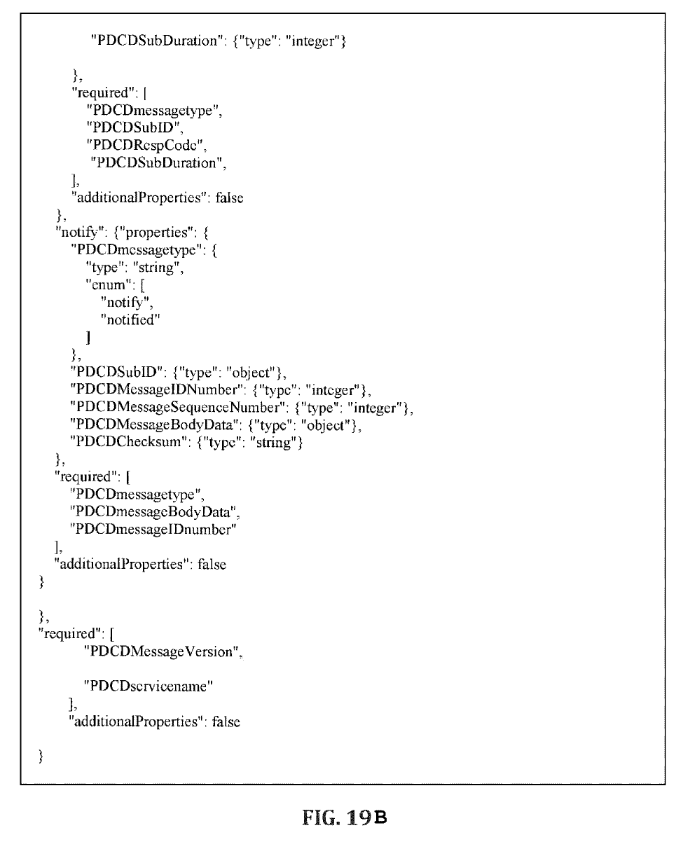

FIG. 19A and FIG. 19B illustrate an exemplary JSON schema for message structure. In some examples the message structure for messages exchanged between PD and CD with various data fields may require that the structure of the message and message body exchanged conform to a defined schema as shown in FIG. 19A and FIG. 19B.

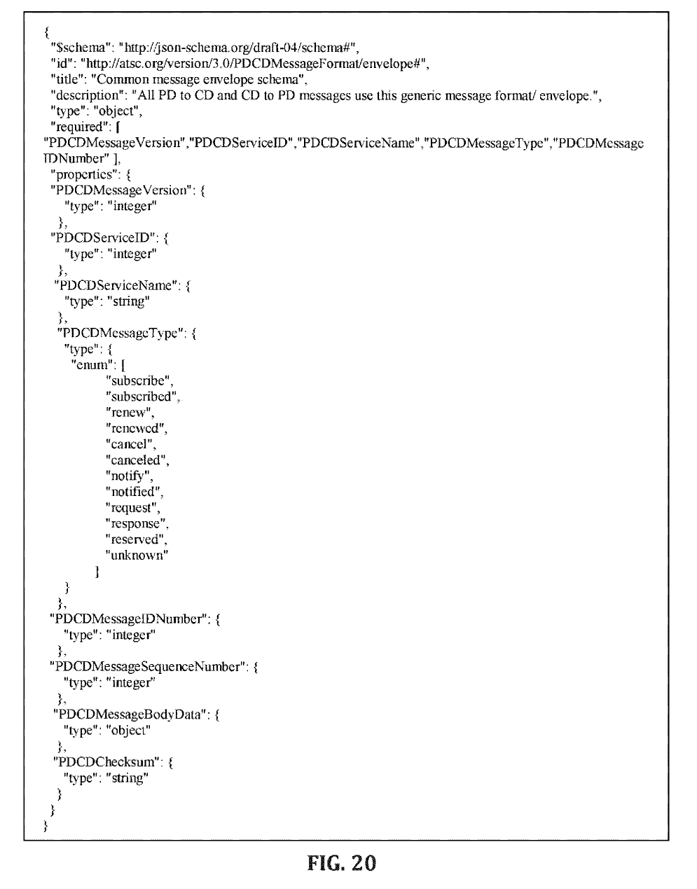

FIG. 20 illustrates a variant JSON schema which does not include conditional inclusion of elements. Thus the JSON construct “one of” is not used in the JSON schema in FIG. 20. In an example the message structure for messages exchanged between PD and CD with various data fields may require that the structure of the message and message body exchanged conform to a defined schema as shown in FIG. 20.

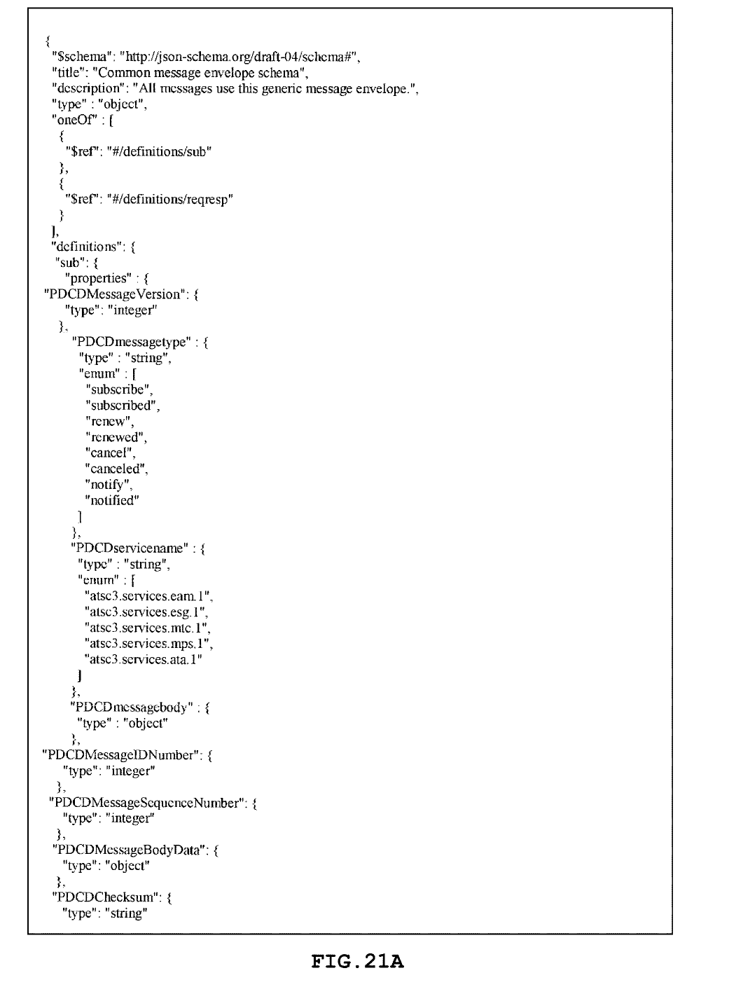

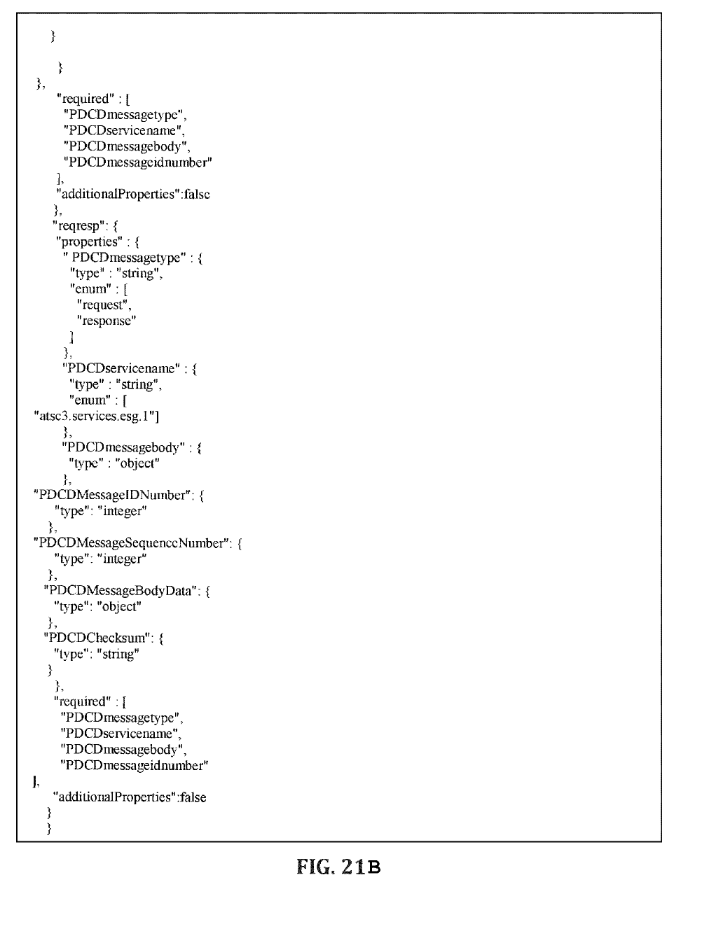

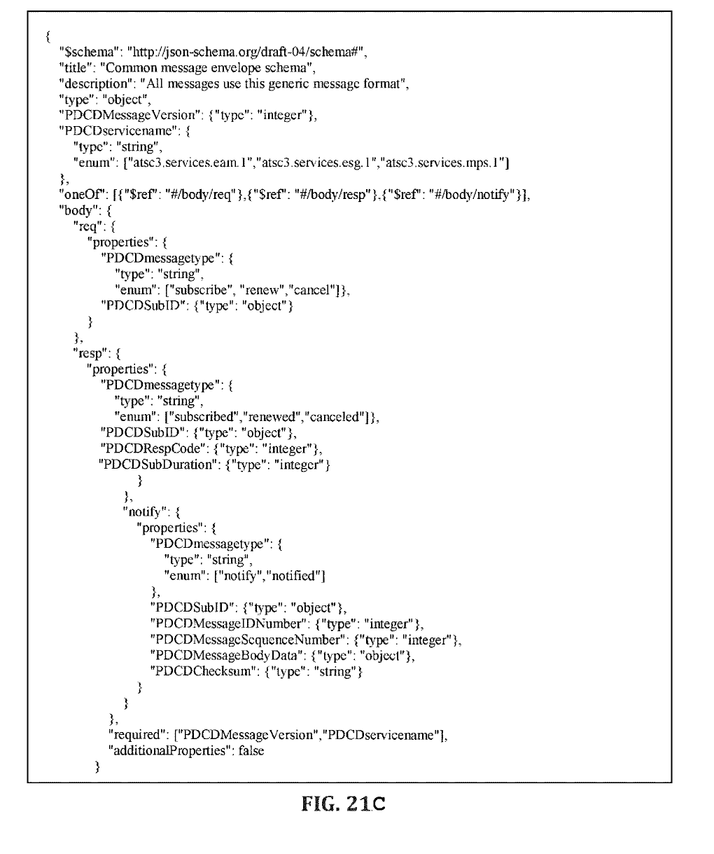

FIG. 21A and FIG. 21B illustrate yet another exemplary JSON schema for message structure. FIG. 21A and FIG. 21B schema splits the messages into subscription type messages related to JSON construct “$ref”: “#/definitions/sub” and request-response type messages related to JSON construct “$ref”: “#/definitions/reqresp”. Using the “OneOf” JSON construct the messages obey one of these two types of structure. The “one of” construct means the JSON data must validate against one of the given sub schemas. In an example the message structure for messages exchanged between PD and CD with various data fields may require that the structure of the message and message body exchanged conform to a defined schema as shown in FIG. 21A and FIG. 21B.

FIG. 21C illustrates yet another more compact JSON schema. Some of the objects are eliminated in FIG. 21C schema compared to previous schemas to create a more efficient and compact representation.

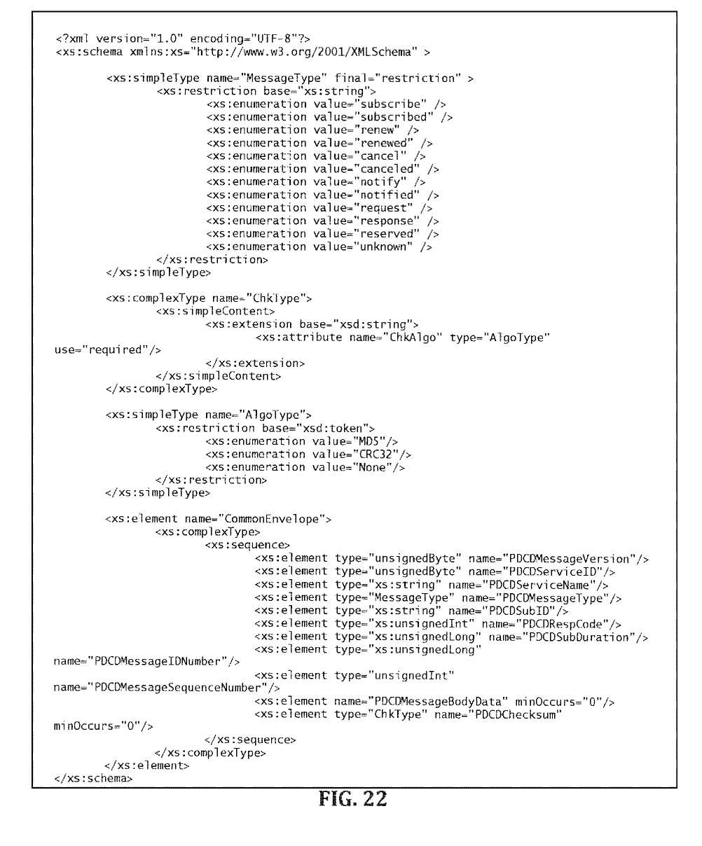

FIG. 22 illustrates an exemplary XML schema for message structure. In an example the message structure for messages exchanged between PD and CD with various data fields may require that the structure of the message and message body exchanged conform to a defined schema as shown in FIG. 22. When using a XML schema and XML format for exchanging messages between PD and CD. The type of elements that can be included in messages from PD to CD and from CD to PD will be restricted semantically as shown in Table 1.

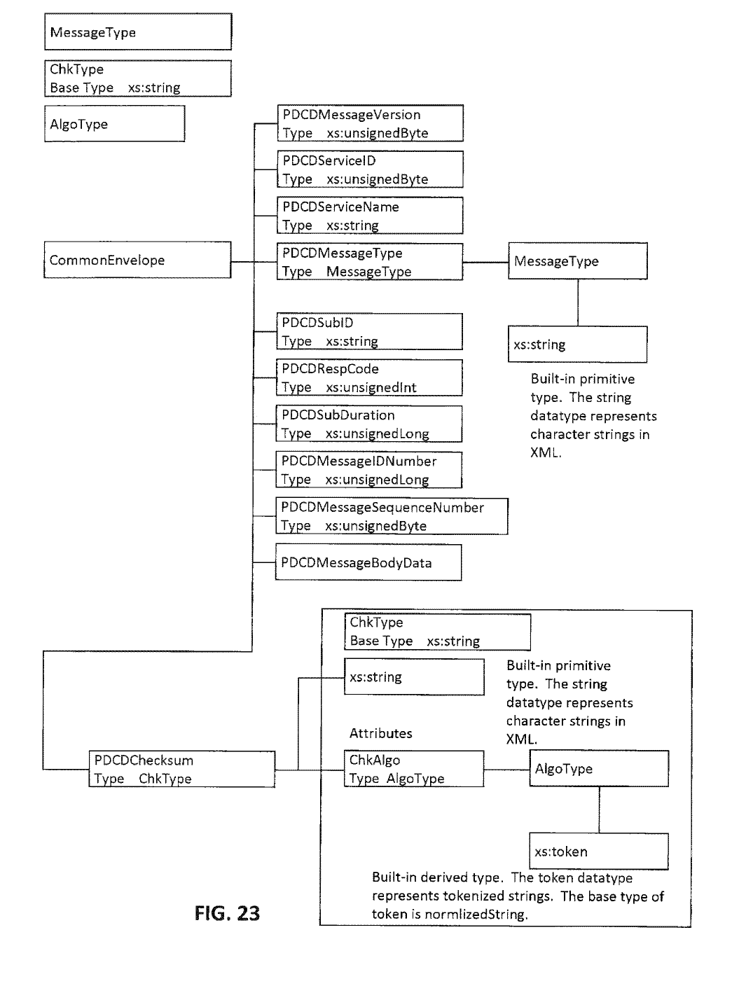

FIG. 23 shows a pictorial representation of various XML schema elements. The XML schema elements may correspond to the XML schema shown in FIG. 22.

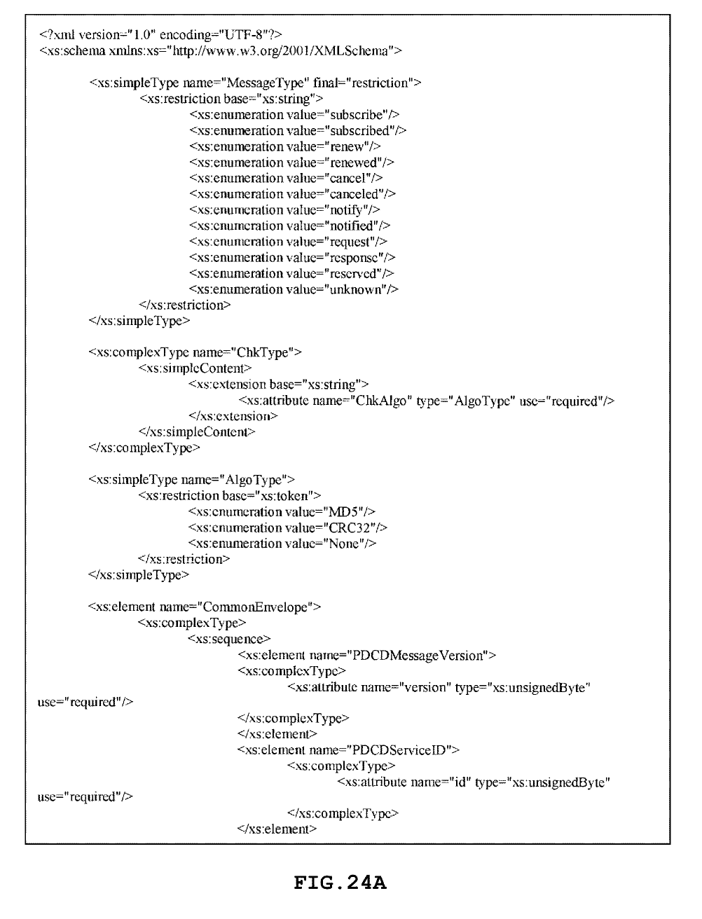

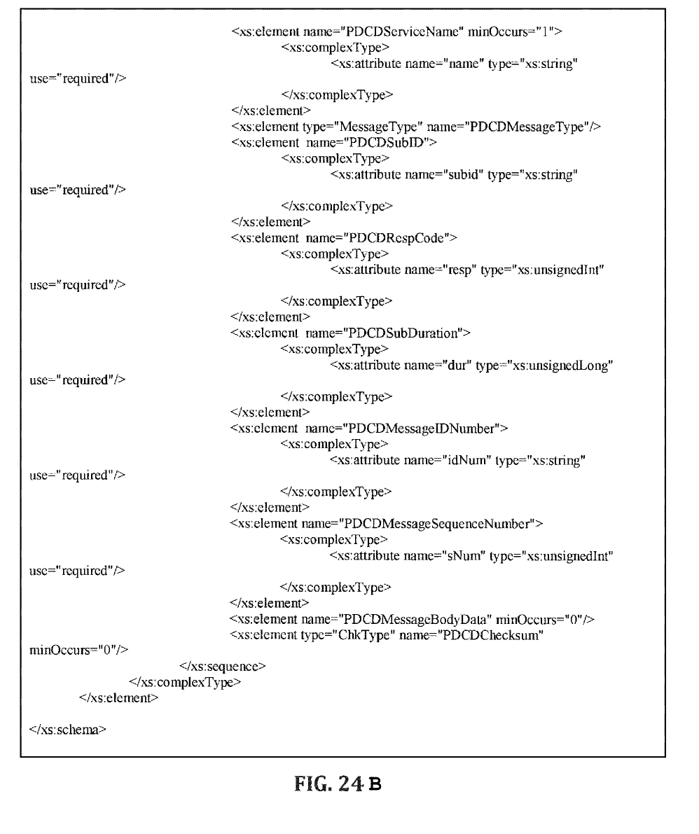

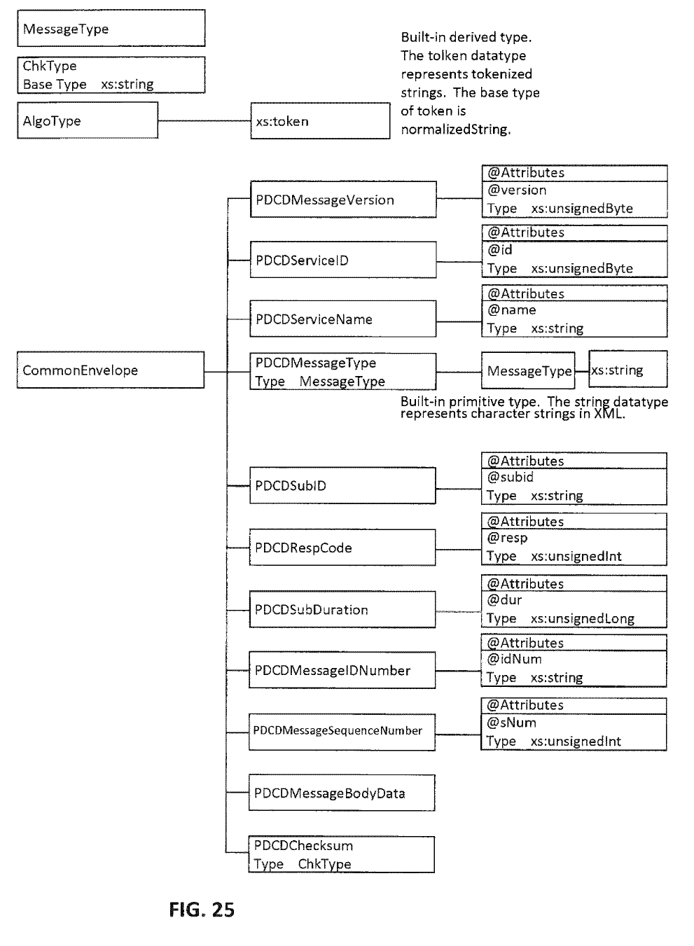

Additionally FIG. 25 shows another pictorial representation of various XML schema elements. The XML schema elements may correspond to the XML schema shown in FIG. 24A and FIG. 24B. One difference between XML schema in FIG. 22 and XML schema in FIG. 24A and FIG. 24B is that in FIG. 24A and FIG. 24B number of properties are included as attributes for the elements rather than including them as part of the element as in FIG. 22.

In another example one or more of the elements shown in FIG. 22 and/or FIG. 24A and FIG. 24B may instead be represented as attributes. In another example some of the attributes shown in FIG. 24A and FIG. 24B may instead be represented as elements.

Both JSON and XML are textual formats. In some case textual formats tend to be more verbose and require more bytes to represent a message and message structure. Under certain circumstances exchanging more compact messages may be desired. In such cases instead of textual formats such as JSON, XML, binary, or bitstream format may be used to define message structure. Several variant binary and/or bitstream formats for message structures are described next.

Table 6 provides an exemplary bitstream syntax for the message structure. The Table 6 shows syntax element name, number of bits used to represent the syntax element and the format of the syntax element. In Table 6 uimsbf representation refers to unsigned integer most significant bit first (uimsbf).

TABLE 6
Bit Stream Syntax of Message Structure

| | | |
|---|---|---|
| Syntax | No. of Bits | Format |

PDCD_Message ( ) {

| | | |
|---|---|---|
| PDCDMessageVersion | 8 | uimsbf |
| PDCDServiceID | 8 | uimsbf |
| PDCDMessageType | 8 | uimsbf |
| if (PDCDMessageType < 0x40) | | |

{

| | | |
|---|---|---|
| PDCDSubID | 8 | uimsbf |
| if ((PDCDMessageType > | | |

0x10) && (PDCDMessageType <
0x20)) {

| | | |
|---|---|---|
| PDCDRespCode | 8 | uimsbf |
| PDCDSubDuration | 16 | uimsbf |

}
else if

( (PDCDMessageType >= 0x20))
{

| | | |
|---|---|---|
| PDCDMessageIDNumber | 16 | uimsbf |
| PDCDMessageSequenceNum | 16 | uimsbf |

ber

| | | |
|---|---|---|
| PDCDMessageBodyLength | 16 | uimsbf |
| if | | |

(PDCDMessageBodyLength>0) {

| | |
|---|---|
| PDCDMessageBodyData ( ) | PDCDMessageBodyLength |

| | | |
|---|---|---|
| } | | |
| PDCDMD5CheckSum | 16*8 | uimsbf |
| PDCDCRC | 32 | uimsbf |

}}

| | | |
|---|---|---|
| else { | | |
| PDCDMessgeExtLen | 16 | Uimsbf |
| PDCDMessageExtData | PDCDMessageExtLen | |
| } | | |

In an alternative example the bitstream syntax for message structure may be as shown below in Table 7. Table 7 shows syntax element name, number of bits used to represent the syntax element and the format of the syntax element. In Table 7 uimsbf representation refers to Unsigned Integer, Most Significant Bit First. In Table 7 compared to Table 6, the syntax elements PDCDMessageBodyLength, PDCDMessageBodyData( ), PDCDMD5CheckSum and PDCDCRC are also sent for PDCDMessageType values less than 0x020.

TABLE 7
Bit Stream Syntax of Message Structure

| | | |
|---|---|---|
| Syntax | No. of Bits | Format |

PDCD_Message ( ) {

| | | |
|---|---|---|
| PDCDMessageVersion | 8 | uimsbf |
| PDCDServiceID | 8 | uimsbf |
| PDCDMessageType | 8 | uimsbf |
| if (PDCDMessageType < 0x40) | | |

{

| | | |
|---|---|---|
| PDCDSubID | 8 | uimsbf |
| if ((PDCDMessageType > | | |

0x10) && (PDCDMessageType <
0x20)) {

| | | |
|---|---|---|
| PDCDRespCode | 8 | uimsbf |
| PDCDSubDuration | 16 | uimsbf |

}
else if

( (PDCDMessageType >= 0x20))
{

| | | |
|---|---|---|
| PDCDMessageIDNumber | 16 | uimsbf |
| PDCDMessageSequenceNum | 16 | uimsbf |

ber
}

| | | |
|---|---|---|
| PDCDMessageBodyLength | 16 | uimsbf |
| if | | |

(PDCDMessageBodyLength>0) {

| | | |
|---|---|---|
| PDCDMessageBodyData ( ) | PDCDMessageBodyLength | |
| PDCDMD5CheckSum | 16*8 | uimsbf |
| PDCDCRC | 32 | uimsbf |

}}
else {

| | | |
|---|---|---|
| PDCDMessgeExtLen | 16 | Uimsbf |
| PDCDMessageExtData | PDCDMessageExtLen | |

}

In an example the bitstream syntax for message structure may be as shown below in Table 8. The Table 8 shows syntax element name, number of bits used to represent the syntax element and the format of the syntax element. In Table 8 uimsbf representation refers to Unsigned Integer, Most Significant Bit First. In Table 8 compared to Table 6, and 7 all the elements are included for all message types.

TABLE 8
Bit Stream Syntax of Channel Descriptor

| | | |
|---|---|---|
| Syntax | No. of Bits | Format |

PDCD_Message ( ) {

| | | |
|---|---|---|
| PDCDMessageVersion | 8 | uimsbf |
| PDCDServiceID | 8 | uimsbf |
| PDCDMessageType | 8 | uimsbf |
| PDCDMessageIDNumber | 16 | uimsbf |
| PDCDMessageSequenceNu | 16 | uimsbf |

mber

| | | |
|---|---|---|
| PDCDMessageBodyLength | 16 | uimsbf |
| if | | |

(PDCDMessageBodyLength>0) {

| | |
|---|---|
| PDCDMessageBodyData ( ) | PDCDMessageBodyLength |

}

| | | |
|---|---|---|
| PDCDMD5CheckSum | 16*8 | uimsbf |
| PDCDCRC | 32 | uimsbf |

}

In yet another alternative example the bitstream syntax for message structure may be as shown below in Table 9. Table 9 shows syntax element name, number of bits used to represent the syntax element and the format of the syntax element. In Table 9 uimsbf representation refers to Unsigned Integer, Most Significant Bit First. In Table 9 compared to Table 6, the syntax elements PDCDRespCode and PDCDSubDuration are only included for response message types. All the other elements are included for request message type, response message type and notification message type.

TABLE 9
Bit Stream Syntax of Message Structure

| | | |
|---|---|---|
| Syntax | No. of Bits | Format |

PDCD_Message ( ) {

| | | |
|---|---|---|
| PDCDMessageVersion | 8 | uimsbf |
| PDCDServiceID | 8 | uimsbf |
| PDCDMessageType | 8 | uimsbf |
| if (PDCDMessageType < 0x40) | | |

{

| | | |
|---|---|---|
| PDCDSubID | 8 | uimsbf |
| if ((PDCDMessageType > | | |

0x10) && (PDCDMessageType <
0x20)) {

| | | |
|---|---|---|
| PDCDRespCode | 8 | uimsbf |
| PDCDSubDuration | 16 | uimsbf |

}

| | | |
|---|---|---|
| PDCDMessageIDNumber | 16 | uimsbf |
| PDCDMessageSequenceNum | 16 | uimsbf |

ber

| | | |
|---|---|---|
| PDCDMessageBodyLength | 16 | uimsbf |
| if | | |

(PDCDMessageBodyLength>0) {

| | |
|---|---|
| PDCDMessageBodyData ( ) | PDCDMessageBodyLength |

| | | |
|---|---|---|
| PDCDMD5CheckSum | 16*8 | uimsbf |
| PDCDCRC | 32 | uimsbf |

}}

| | | |
|---|---|---|
| else { | | |
| PDCDMessgeExtLen | 16 | Uimsbf |
| PDCDMessageExtData | PDCDMessageExtLen | |
| } | | |

With respect to Tables 6, 7, 8, 9, following semantics are defined for various syntax elements in those Tables.

PDCDMessageVersion—This 8-bit unsigned integer shall indicate the version of this PD-CD message structure. The most significant six bits of PDCDMessageVersion shall indicate the major version and the least significant two bits the minor version of the PD-CD message structure. The version of this message structure shall be 0x004 i.e. version 1.0.

PDCDMessageServiceID—This 8-bit field shall specify the service identifier which uniquely identifies the PD-CD service. The service identifier values are as defined in Table 2.

The PDCDServiceID field for messages defined in this version of this specification shall take values in the range 0-5, inclusive. PD and CD conforming to this version of this specification shall be capable of ignoring a message received with PDCDServiceID value other than 0-5.

PDCDMessageType—This 8-bit field shall identify the type of message. The message identifier values are as defined in Table 4. Allowed direction (from PD to CD or from CD to PD) for message types shall be as defined in the Table 4.

PDCDSubID—This 8-bit field shall specify the subscription identifier for this subscription. PDCDSubID is used to uniquely identify this subscription between CD to the PD. A PDCDSubID value of 0 is reserved.

PDCDRespCode—This 8-bit field shall specify a success or failure status code for the corresponding request identified by the PDCDSubID field value in the message.

PDCDSubDuration—This 16-bit field specifies subscription duration in seconds. Indicates duration for which subscription is active.

PDCDMessageIDNumber—This 16-bit field shall specify a unique identifier for the message. This field can be used for duplicate detection. A message with a PDCDMessageIDNumber value of mIDA shall have at least one of its message field values different compared to a message with a PDCDMessageIDNumber value of mIDB when mIDA is not equal to mIDB.

PDCDMessageSequenceNumber—This 16-bit field shall specify a sequence number for the message. The sequence number field shall be incremented by one for each new message. The sequence number field shall wrap back to 0 when it reaches the maximum supported value. PDCDMessageBodyLength—This 16-bit field shall specify the number of bytes of

PD-CD message body data that immediately follows this field. A value of zero indicates the field PDCMessageBodyData is absent.

PDCDMessageBodyData—This field of length PDCDMessageBodyLength shall specify the number of bytes of PD-CD message body data. The format of PDCMessageBodyDatas shall obey the syntax of the particular service type and message type.

PDCDMD5Checksum—MD5 checksum for the entire message.

Alternatively MD5 checksum for the field PDCDMessageBodyData (or CRC for the field PDCDMessageBodyData). MD5 message digest is defined in IETF RFC 1321 as specified in https://www.ietf.org/rfarfc1321.txt

PDCDCRC—This 32-bit field shall contain CRC value for the entire message. This 32-bit field shall contains the CRC value that gives a zero output of the registers in the decoder defined in International Standards Organization (ISO)/International Electrotechnical Commission (IEC) 13818-1, Annex A (which is incorporated herein by reference) after processing the entire message. The generating polynomial is 1+x+x2+x4+x5+x7+x8+x10+x11+x12+x16+x22+x23+x26.

Alternatively a CRC with 32-bit checksum (CRC32) may be only for the field PDCDMessageBodyData.

PDCDMessageExtLen—This 16-bit field shall specify the number of bytes of PD-CD message extension data that immediately follows this field. A value of zero indicates the field PDCMessageExtData is absent.

PDCDMessageExtData—This field of length PDCDMessageExtLen shall specify the number of bytes of PD-CD message extension data. The format of PDCMessageExtDatas shall obey the syntax of the particular service type and message type.

With respect to Table 6, 7, 8, 9 it should be noted that although specific values of PDCDMessageType are used to determine which elements are included, the check for actual values may be different. In Tables 6, 7, 8, 9, the PDCDMessageType values between 0x00 and 0x0F are request message types, PDCDMessageType values between 0x10 and 0x1F are response message types, and PDCDMessageType values between 0x20 and 0x3F are notification message types. Thus if the message type values for these types of messages are changed the corresponding if or else or else if statements in Table 6, 7, 8, 9 will be changed accordingly.

Although the syntax elements shown in Table 6, 7, 8, 9 use uimsbf format some other format (e.g. unsigned byte or integer format or signed integer format, etc.) could instead be used.

Although not explicitly shown additional variant bitstream format can be created by conditionally including some but not the other syntax elements depending upon the message type. These are intended to be covered by this invention.

Although Table 6, 7, 8, 9 show both message elements PDCDMD5CheckSum and PDCDCRC, in some examples only one of these two elements may be included. In yet another example none of these two message elements PDCDMD5CheckSum and PDCDCRC may be included in the message structure. In yet another example one or both of these two elements (PDCDMD5CheckSum and PDCDCRC) may only be included in the “Notification Message that is sent to subscribers” message shown in Table 4, Table 5 and Table 41.

With respect to Table 6, 7, 8, 9, instead of putting restrictions on which syntax elements are included in which message types in the table syntax, those restrictions could be placed as semantic constraints. For example one or more of the following semantic constraints may be defined for syntax elements:

PDCDSubID element which indicates the subscription identifier shall be included in all the messages except the message to request subscription (i.e. Message type 0 or MessageType enumeration “subscribe” in Table 41).

PDCDRespCode element which indicates success or failure response code shall only be included in response message (i.e. Message type 16 or MessageType enumeration “subscribed”; Message type 17 or MessageType enumeration “canceled”; Message type 18 or MessageType enumeration “renewed”; Message type 19-31 or MessageType enumeration “response”; in Table 41). Thus PDCDRespCode element shall not be included in response message types and in the notification message that is sent to the subscribers. In one example PDCDRespCode element which indicates response code shall be included in a message only when MessageType is response message type.

PDCDSubDuration element which indicates duration for which subscription is active shall only be included in response message (i.e. Message type 16 or MessageType enumeration “subscribed”; Message type 17 or MessageType enumeration “canceled”; Message type 18 or MessageType enumeration “renewed”; Message type 19-31 or MessageType enumeration “response”; in Table 41). Thus PDCDSubDuration element shall not be included in request message types and in the notification message that is sent to the subscribers. In some examples additionally the PDCDSubDuration element shall not be included in Message type 17 or MessageType enumeration “canceled”. In some examples for Message type 17 or MessageType enumeration “canceled”, the value of PDCDSubDuration shall be equal to 0. In one example PDCDSubDuration element which indicates subsciption duration shall be included in all messages except for “cancel” and “canceled” message type shown in Table 41 or except in any cancel related message type.

In some examples the PDCDMessageIDNumber and/or PDCDMessageSequenceNumber elements shall be included only in the notification message that is sent to the subscribers (i.e. Message type 32 or MessageType enumeration “notify” in Table 41).

In some examples the PDCDMD5CheckSum and/or PDCDCRC elements shall be included only in the notification message that is sent to the subscribers (i.e. Message type 32 or MessageType enumeration “notify” in Table 41).

Further information regarding PD and CD side handling of messages (multiplexing and demultiplexing) is defined. In one example one underlying WebSocket connection between PD and CD application (CD App) or between CD and PD application (PD App) or between PD App and CD App can be used to exchange messages belonging to different services and/or message belonging to multiple instances of same service using the message structure schema defined. This allows reusing the same underlying WebSocket and TCP connection for exchanging messages between PD and CD. This approach has the benefit of not needing to establish separate WebSocket connection for each service or multiple instances of the same service, which could result in reduced resource (e.g., energy, memory) consumption on CD. Additionally latency needed to establish a WebSocket connection for each service or for multiple instances of the same service is reduced as an already established WebSocket connection can be used for message communication.

PD and CD can use the defined message structure to send messages belonging to different services and/or message belonging to multiple instances of same service on the same WebSocket connection.

When a PD or CD receives a message based on the defined message structure, it may decode the PDCDServiceID or PDCDServiceName field to identify the type of service between PD and CD that this message belongs to.

When a PD or CD receives a message based on the defined message structure, it may decode the PDCDSubID field to identify the instance of service between PD and CD that this message belongs to.

When PDCDServiceID or PDCDServiceName of a message msgA is same as PDCDServiceID or PDCDServiceName of a message msgB if the value of PDCDSubID field for msgA and msgB are the same then the two messages (msgA and msgB) belong to the same service instance otherwise they belong to different service instance.

Another example is now defined for message structure for message communication between PD and CD.

Instead of only one message structure for communication between PD and CD, two message structures are defined.

The subscription message structure consists of six different message types and is used for subscription related messages A notification message structure is used for notification message.

These are described in detail below.

Details about Subscription Message Structure are described next.

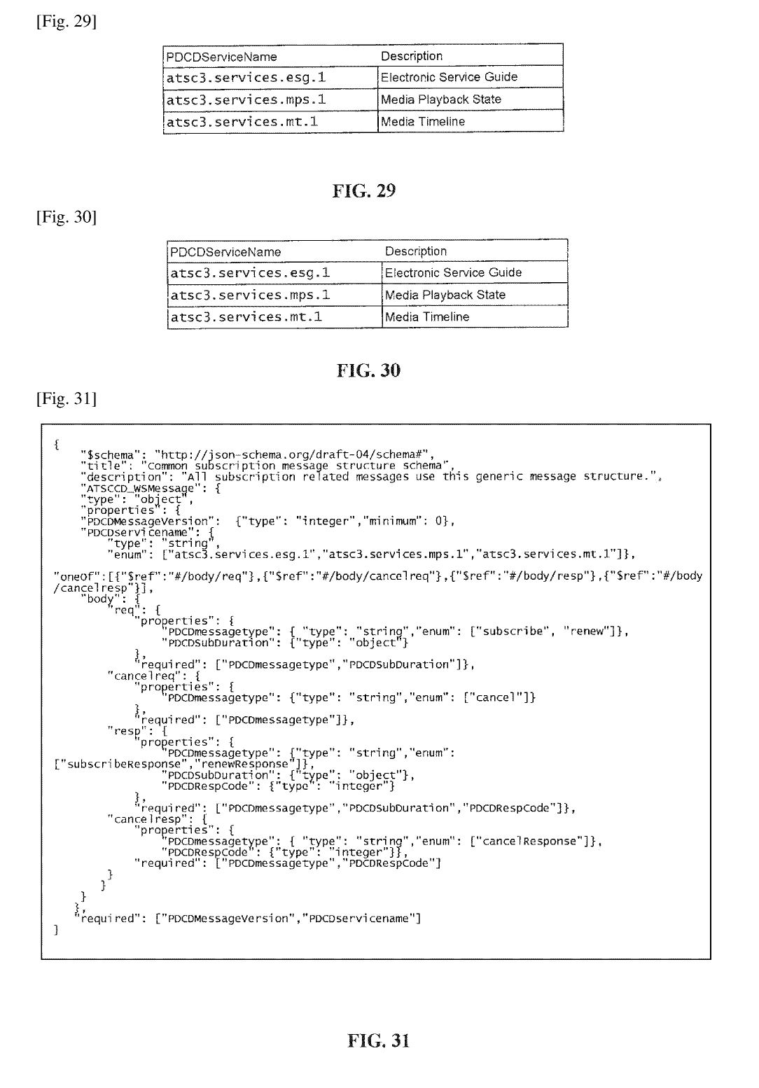

Various subscription related messages between PD and CD use subscription message structure shown in Table 10. Table 11 lists various supported service enumeration values. In another example the subscription related service enumeration values may be as shown in FIG. 29. Table 12 lists supported message type enumeration values.

TABLE 10
Subscription Message structure

| Element | | Data | Included in | |
|---|---|---|---|---|
| Name | Cardinality | type | Message Type | Description |
| PDCDServiceName | 1 | String | All | The service name, which uniquely identifies the PD-CD |
| | | | | service. The enumerated service name values are as |
| | | | | defined in Table 11. PD and CD conforming to this |
| | | | | version of this specification shall be capable of ignoring |
| | | | | a message received with PDCDServiceName other than |
| | | | | the names defined in Table 11. |
| PDCDMessageType | 1 | String | All | Identifies the type of message. The message type |
| | | | | enumeration values are as defined in Table 12. Two |
| | | | | categories of message types are defined. This includes |
| | | | | request message types, response message types. |
| | | | | Depending upon the message type (identified by the |
| | | | | PDCDMessageType element) the rest of the message |
| | | | | structure contains different type of message elements. |
| PDCDRespCode | 1 | Unsigned | Response | A success or failure status code for the corresponding |
| | | Integer | Message Types | request. |
| PDCDSubDuration | 1 | Unsigned | All except | Subscription duration. When the message is sent from |
| | | Integer | cancel and | CD to PD this element indicates requested subscription |
| | | | cancelResponse | duration. When the message is sent from PD to CD this |
| | | | | element indicates duration for which subscription is |
| | | | | active. |

TABLE 11
Service enumeration values

| PDCDServiceName | Description |
|---|---|
| atsc3.services.esg.1 | Electronic Service Guide |
| atsc3.services.mps.1 | Media Playback State |
| . . . | |

TABLE 12
Message type enumeration values

| | | |
|---|---|---|
| Message Type | | Allowed direction for |
| Enumeration | Description | this message type |

Request Message Types

| | | |
|---|---|---|
| subscribe | Message to request a subscription | From CD to PD |
| cancel | Message to cancel a subscription | From CD to PD |
| renew | Message to renew a subscription | From CD to PD |

Response Message Types

| | | |
|---|---|---|
| subscribeResponse | Response Message to the subscription | From PD to CD |
| | request | |
| cancelResponse | Response Message to the cancel | From PD to CD |
| | request | |
| renewResponse | Response Message to the renew | From PD to CD |
| | request | |

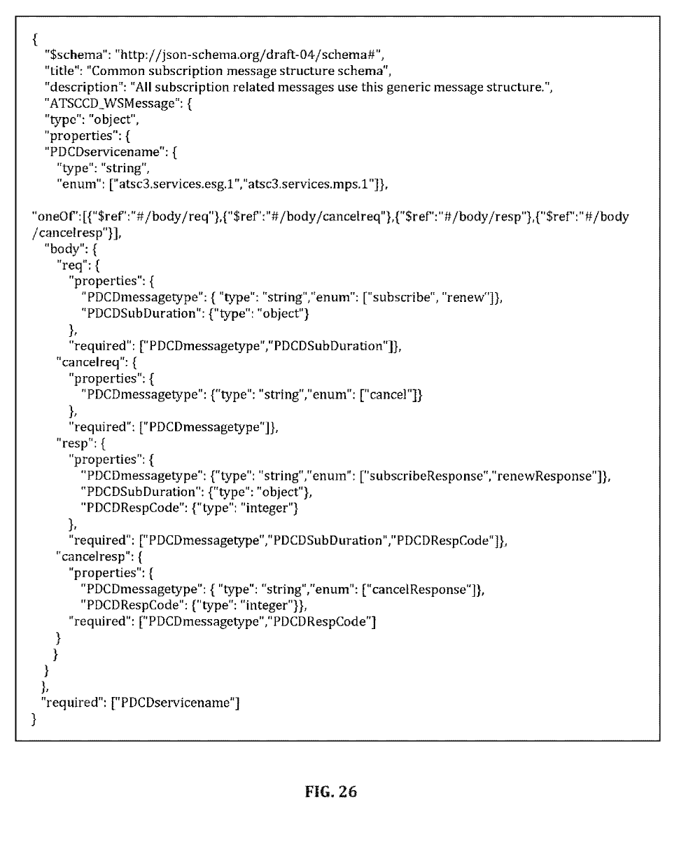

In one example the subscription related messages from PD to CD and from CD to PD shall be sent in JSON format conforming the JSON schema shown in FIG. 26.

In one example the subscription related messages from PD to CD and from CD to PD shall be sent in JSON format conforming the JSON schema shown in FIG. 31.

In a variant example an additional element may be added to Table 10 to indicate version of the subscription message structure as shown below.

| | | | Included in | |
|---|---|---|---|---|
| Element | | | Message | |
| Name | Cardinality | Data type | category | Description |
| PDCDMessageVersion | 1 | Unsigned | All | Version of this subscription message structure. The |
| | | Integer | | upper 6 bits shall indicate major version and lower two |
| | | | | bits shall indicate minor version. The version of this |
| | | | | subscription message structure shall be 0x004 i.e. |
| | | | | version 1.0. |

Details about Notification Message Structure are described next.

Notification messages are sent from PD to CD and use the notification message structure shown in Table 13 below. Table 14 lists supported notification service enumeration values. In another example the notification service enumeration values may be as shown in FIG. 30.

TABLE 13
Notification Message Structure

| Element | | Data | |
|---|---|---|---|
| Name | Cardinality | type | Description |
| PDCDServiceName | 1 | String | The service name, which uniquely identifies the PD-CD |
| | | | service. The enumerated service name values are as |
| | | | defined in Table 14. PD and CD conforming to this |
| | | | version of this specification shall be capable of ignoring |
| | | | a message received with PDCDServiceName other than |
| | | | the names defined in Table 14. |
| PDCDMessageBodyData | 0..1 | Bytes | Message specific data elements. The syntax and |
| | | | semantics of the PDCDMessageBodyData is defined in |
| | | | individual messages of individual services. |

TABLE 14
Notification service enumeration values

| PDCDServiceName | Description |
|---|---|
| atsc3.services.esg.1 | Electronic Service Guide |
| atsc3.services.mps.1 | Media Playback State |
| . . . | |

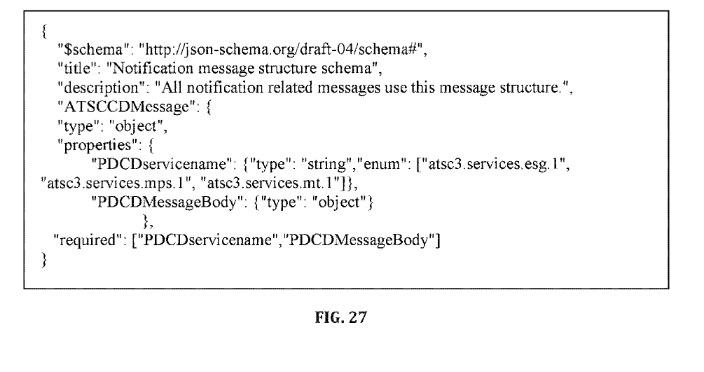

The notification messages can be sent only from PD to CD. These messages from PD to CD shall be sent in JSON format conforming the JSON schema shown in Annex in FIG. 27.

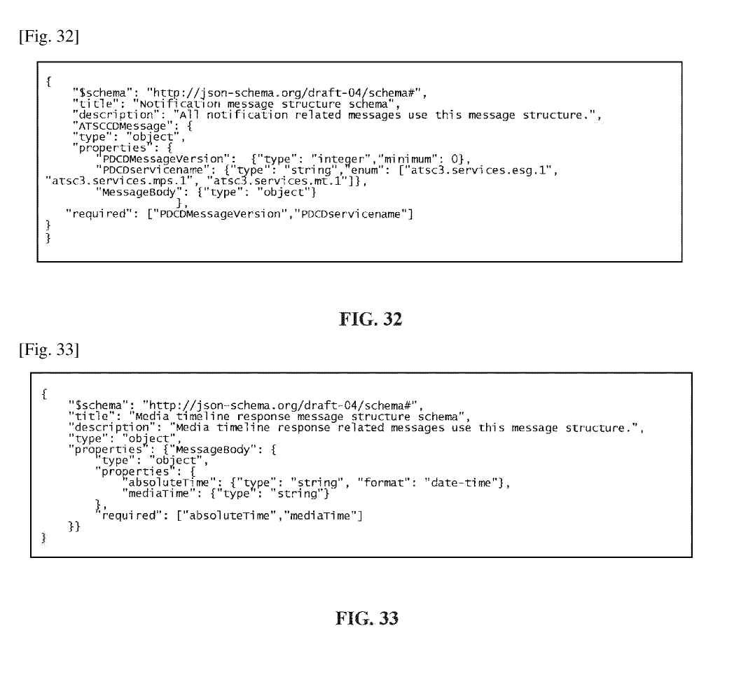

In one example the notification messages can be sent only from PD to CD. These messages from PD to CD shall be sent in JSON format conforming the JSON schema shown in FIG. 32.

In a variant example an additional element may be added to Table 13 to indicate version of the notification message structure as shown below.

| Element | | | |
|---|---|---|---|
| Name | Cardinality | Data type | Description |
| PDCDMessageVersion | 1 | Unsigned | Version of this notification message structure. The upper |
| | | Integer | 6 bits shall indicate major version and lower two bits |
| | | | shall indicate minor version. The version of this |
| | | | notification message structure shall be 0x004 i.e. version |
| | | | 1.0. |

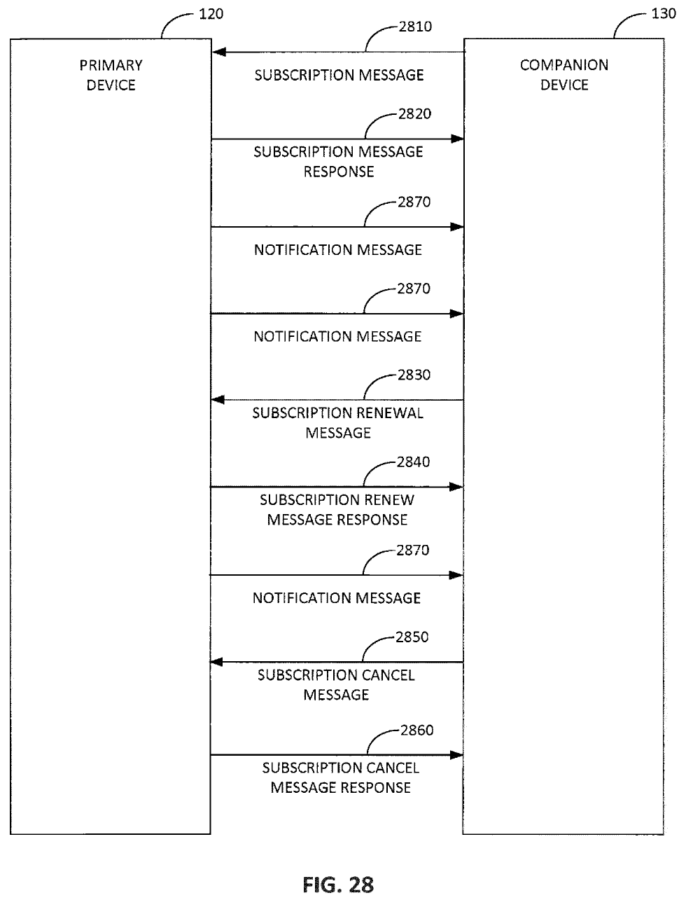

Exemplary steps in the message protocol sequence and message structure data fields used in each message protocol sequence are defined next. Referring to FIG. 28, to receive notification messages over WebSocket, a primary device (PD) 120 and a companion device (CD) 130 communicate as follows:

CD 130 sends a subscription message 2810 to PD 120 having a format as described Table 10 Subscription Message Format. For this message PDCDServiceName is set to one of the service names in the PDCDServiceName column in Table 11 (e.g. “atsc3.services.esg.1” or “atsc3.services.mps.1”) and PDCDMessageType is set to “subscribe.” This subscription message shall include a requested subscription duration value in PDCDSubDuration field.

Upon receiving a subscription message 2810 from CD 130, PD 120 if it supports the service in the received PDCDServiceName field, sends a subscription message response 2820 to CD 130 having the Subscription Message Format of Table 10. For this message the PDCDServiceName field is set to the same name as in PDCDServiceName (e.g. “atsc3.services.esg.1” or “atsc3.services.mps.1”) in the subscription message received by the PD and PDCDMessageType is set to “subscribeResponse.” In this message PD 120 includes in PDCDSubDuration field a PDCDSubDuration value for which the subscription is valid.

When a current subscription ends at the indicated PDCDSubDuration, the CD 130 may continue to receive a notification message for the service by sending a subscription renewal message 2830 to PD 120 with the format specified in Table 10, Subscription Message Format. In this message PDCDServiceName is set to the same service name as was used in the subscription message (above) (e.g. “atsc3.services.esg.1” or “atsc3.services.mps.1”) and PDCDMessageType is set to “renew.” This subscription message shall include a requested subscription duration value for this renewal request in the PDCDSubDuration field.

Upon receiving a subscription renewal message 2830 from CD 130, PD 120 may send a subscription renew message response 2840 to CD in the Subscription Message Format illustrated in Table 10. For this message PDCDServiceName is set to the same name as the PDCDServiceName (e.g. “atsc3.services.esg.1” or “atsc3.services.mps.1”) in the subscription renewal message received by the PD and PDCDMessageType is set to “renewResponse.” In this message PD 120 includes a PDCDSubDuration value for which the renewed subscription is valid in the PDCDSubDuration field.

At any time while subscribed, CD 130 may send a subscription cancel message 2850 to PD 120 as specified in the Subscription Message Format in Table 10. In this message PDCDServiceName is set to the same service name as used in the subscription message (above) or in the subscription renewal message (above) (e.g. “atsc3.services.esg.1” or “atsc3.services.mps.1”) and PDCDMessageType is set to “cancel.”

Upon receiving a subscription cancel message 2850 from CD 130, if the CD 130 is currently subscribed with this PD 120 to receive the service corresponding to the value included in the PDCDServiceName field of the subscription cancel message, PD 120 sends a subscription cancel message response 2860 to CD 130 in the Subscription Message Format described in Table 10. In this message the PDCDServiceName is set to the same name as in PDCDServiceName (e.g. “atsc3.services.esg.1” or “atsc3.services.mps.1”) in the subscription cancel message received by the PD and PDCDMessageType set to “cancelResponse.”

Once a CD 130 is subscribed with a PD 120 for a particular service, the PD 120 can send a notification message 2870 to the subscribed CD 130 at any time. For this the PD uses the Notification message structure as specified in Table 13. In this message the PDCDServiceName is set to the name of the service (e.g. “atsc3.services.esg.1” or “atsc3.services.mps.1”) for which the notification is sent and for which the CD 130 is subscribed with the PD 120. The MessageBody is set to the MessageBody as defined for the service.

Other variants of the communication protocol are specific to different types of service (e.g. electronic service guide service or media playback state service). For example, for Electronic Service Guide (ESG) service or “service and content identification” a PD 120 and a CD 130 for communicate over WebSocket as follows.

To start receiving notification messages, CD 130 sends a subscription message 2810 to PD 120 in the Subscription Message Format described in Table 10. For this message PDCDServiceName is set to “atsc3.services.mps.1” and PDCDMessageType is set to “subscribe.” This subscription message includes a requested subscription duration value in the PDCDSubDuration field.

Upon receiving a subscription message 2810 from CD 130, PD 120 if it supports the the service in the PDCDServiceName field in the subscription message 2810 sends a subscription message response 2820 to CD 130 in the Subscription Message Format of Table 10. For this message PDCDServiceName field is set to “atsc3.services.mps.1” and PDCDMessageType is set to “subscribeResponse.” In this message PD 120 includes a PDCDSubDuration value for which the subscription is valid in the PDCDSubDuration field.

When a current subscription ends at indicated the PDCDSubDuration, the CD 130 may continue to receive a notification message for the service by sending a subscription renewal message 2830 to PD 120 in the Subscription Message Format of Table 10. In this message PDCDServiceName is set to “atsc3.services.mps.1” and PDCDMessageType is set to “renew.” A requested subscription duration value for this renewal subscription is inserted in PDCDSubDuration field of the subscription renewal message.

Upon receiving a subscription renewal message 2830 from CD 130, PD 120 sends a subscription renew message response 2840 to CD 130 as specified in the Subscription Message Format of Table 10. For this message PDCDServiceName is set to “atsc3.services.mps.1” and PDCDMessageType is set to “renewResponse.” In this message PD 120 includes a PDCDSubDuration value for which the renewed subscription is valid in PDCDSubDuration field.

At any time when subscribed, CD 130 may send a subscription cancel message 2850 to PD 120 as specified Subscription Message Format in Table 10. In this message PDCDServiceName is set to “atsc3.services.mps.1” and PDCDMessageType is set to “cancel.”

Upon receiving a subscription cancel message 2850 from CD 130, if the CD 130 is currently subscribed with this PD 120 to receive the service corresponding to the value included in the PDCDServiceName field of the subscription cancel message, PD 120 sends a subscription cancel message response 2860 to CD 130 in the Subscription Message Format described in Table 10. In this message PDCDServiceName is set to “atsc3.services.mps.1” and PDCDMessageType is set to “cancelResponse.”

Once a CD 130 is subscribed with a PD 120 for a particular service, the PD 120 can send a notification message 2870 to the subscribed CD 130 at any time. For this the PD uses the Notification message structure as specified in Table 13. In this message the PDCDServiceName is set to “atsc3.services.mps.1.” The MessageBody is set to the MessageBody as defined for the service.

The following steps are performed by a PD 120 and a CD 130 for communication over WebSocket for Media Playback State Communication service.

CD 130 sends a subscription message 2810 to PD 120 in the Subscription Message

Format of Table 10. For this message PDCDServiceName is set to “atsc3.services.esg.1” and PDCDMessageType is set to “subscribe.” This subscription message includes a requested subscription duration value in PDCDSubDuration field.

Upon receiving a subscription message 2810 from CD 130, PD 120 supporting the service in the received PDCDServiceName field sends a subscription message response 2820 to CD 130 in the Subscription Message Format of Table 10. For this message PDCDServiceName field is set to “atsc3.services.esg.1” and PDCDMessageType is set to “subscribeResponse.” In this message PD 120 a PDCDSubDuration value for which the subscription is valid is included in PDCDSubDuration field.

When a current subscription ends at the indicated PDCDSubDuration, the CD 130 may continue to receive a notification message for the service by sending a subscription renewal message 2830 in the Subscription Message Format of Table 10 to PD 120. In this message PDCDServiceName is set to “atsc3.services.esg.1” and PDCDMessageType is set to “renew.” A requested subscription duration value for this renewal request is included in the PDCDSubDuration field.

Upon receiving a subscription renewal message 2830 from CD 130, PD 120 sends a subscription renew message response 2840 to CD in the Subscription Message Format described in Table 10. For this message the PDCDServiceName is set to “atsc3.services.esg.1” and the PDCDMessageType is set to “renewResponse.” PD 120 includes a PDCDSubDuration value for which the renewed subscription is valid in the PDCDSubDuration field of subscription renew message response.

At any time when subscribed, CD 130 may send a subscription cancel message 2850 to PD 120 as described in the Subscription Message Format of Table 10. In this message PDCDServiceName is set to “atsc3.services.esg.1” and PDCDMessageType is set to “cancel.”

Upon receiving a subscription cancel message 2850 from CD 130, if the CD 130 is currently subscribed with this PD 120 to receive the service corresponding to the value included in the PDCDServiceName field of the subscription cancel message, PD 120 sends a subscription cancel message response 2860 to CD 130 in the Subscription Message Format described in Table 10. In this message PDCDServiceName is set to “atsc3.services.esg.1” and PDCDMessageType is set to “cancelResponse.”

Once a CD 130 is subscribed with a PD 120 for a particular service, the PD 120 can send a notification message 2870 to the subscribed CD 130 at any time. For this the PD uses the Notification message structure as specified in Table 13. In this message the PDCDServiceName is set to “atsc3.services.esg.1.” The MessageBody is set to the MessageBody as defined for the service.

Although various figures and tables in this invention show particular examples of syntax, semantics and schema, additional variants are possible. These include the following variations:

Different data types may be used for an element compared to those shown above. For example instead of unsigned byte data type unsigned short data type may be used. In another example instead of unsigned byte data type a string data type may be used.

Instead of signaling a syntax as an attribute it may be signaled as an element. Instead of signaling a syntax as an element it may be signaled as an attribute.

The bit width of various fields may be changed for example instead of 4 bits for an element or a field in the bitstream syntax 5 bits or 8 bits or 2 bits or 38 bits may be used. The actual values listed here are just examples.

In some examples instead of a range of code values from x to y, a range of code values from x+p or x−p to y+d or y−d may be kept reserved. For example instead of range of code values from 2-255 being kept reserved, the range of code values from 3-255 may be kept reserved.

Instead of XML format and XML schema JSON format and JSON schema may be used. Alternatively the proposed syntax elements may be signaled using a Comma Separated Values (CSV), Backus-Naur Form (BNF), Augmented Backus-Naur Form (ABNF), or Extended Backus-Naur Form (EBNF).

Cardinality of an element and/or attribute may be changed. For example For example cardinality may be changed from “1” to “1 . . . N” or cardinality may be changed from “1” to “0 . . . N” or cardinality may be changed from “1” to “0 . . . 1” or cardinality may be changed from “0 . . . 1” to “0 . . . N” or cardinality may be changed from “0 . . . N” to “0 . . . 1”.

An element and/or attribute may be made required when it is shown above as optional. An element and/or attribute may be made optional when it is shown above as required.

Some child elements may instead be signaled as parent elements or they may be signaled as child elements of another child elements.

It is to be understood that all references to “shall” may be “may” or omitted, as desired.

It is to be understood that the claims are not limited to the precise configuration and components illustrated above. Various modifications, changes and variations may be made in the arrangement, operation and details of the systems, methods, and apparatus described herein without departing from the scope of the claims.

Moreover, each functional block or various features of the base station device and the terminal device (the video decoder and the video encoder) used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array signal (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

1. A method for a companion device to receive, in response to a subscription requested from said companion device to a primary device, a subscription message and a notification message comprising:
(a) receiving said subscription message that includes service enumeration value that includes a value indicating media timeline service;
(b) receiving said notification message that includes notification service enumeration value that includes a value indicating media playback state value; and
(c) processing said subscription based upon said subscription message and said notification message.

2. The method of claim 1 further receiving a media timeline information as an object that has properties that includes an absolute time of type string with a format of date-time and a media time of type string.

3. The method of claim 2 wherein said receiving said media timeline information is in a manner conforming to a subscription JSON schema that includes a first message version having a type of integer and a minimum value of 0.

4. The method of claim 3 further receiving a media playback state information is in a manner conforming to a notification JSON schema that includes a second message version having a type of integer and a minimum value of 0.
